(19) United States
(12) Patent Application Publication
(10) Pub. No.: US 2010/0080436 A1
(43) Pub. Date: Apr. 1, 2010

(54) RADIOGRAPHIC IMAGING DEVICE AND RADIOGRAPHIC IMAGING SYSTEM

(75) Inventor: Hiromu Ohara, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 12/527,611

(22) PCT Filed: Jan. 24, 2008
(86) PCT No.: PCT/JP2008/050967

§ 371 Date: Aug. 18, 2009

(30) Foreign Application Priority Data
Feb. 21, 2007 (JP) 2007-041396
Feb. 21, 2007 (JP) 2007-041432
Feb. 21, 2007 (JP) 2007-041448

(51) Int. Cl. G06K 9/00; G01N 23/04

(52) U.S. Cl. 382/132; 378/62

(57) ABSTRACT

A radiographic imaging device for capturing an excellent X-ray image in which the contrast of edge portions such as a cartilage tissue of a human body is enhanced by using a Talbot interferometer, and a radiographic imaging system for processing the captured image. The radiographic imaging device comprises an X-ray tube for applying X-rays having an average energy of 15 to 60 keV, a first diffraction grating for diffracting X-rays transmitted through a subject (H) to produce the Talbot effect, a second diffraction grating for diffracting X-rays diffracted by the first diffraction grating, and an X-ray detector for detecting X-rays diffracted by the second diffraction grating. The second diffraction grating is disposed in contact with the X-ray detector. The distance L between the X-ray tube and the first diffraction grating is 0.5 m or more. The distance Z₁ between the first and second diffraction gratings is 0.05 m or more. The focus diameter a of the X-ray tube is 1 μm or more.

### TECHNICAL FIELD

The present invention relates to a radiation image radiographing apparatus (radiographic imaging device) and a radiation image radiographing system (radiation imaging system), and especially relates to a radiation image radiographing apparatus employing a Talbot interferometer system and a radiation image radiographing system to conduct a processing for an image captured by the radiation image radiographing apparatus.

### BACKGROUND ART

The disease rate of rheumatic disease in Japan has reached to even 1%, and, now, the rheumatic disease is made into a folk disease. As its early symptoms, the abrasion of cartilaginous portions (cartilage destruction) and some changes in minute bone geometries and bone trabeculae are observed, and at the stage where the symptom advanced, big changes in configurations of a bony part are observed. Therefore, since it is possible to diagnose the disease condition of a rheumatic disease by observing changes in the configurations of cartilaginous parts, minute bone geometries, and bone trabeculae, it is important to take medical care by early detection at the current situation that only a method of therapy to stop the progress of a symptom is available.

However, it is very difficult to detect the above-mentioned early symptoms of rheumatic disease from an X-ray radiograph which is an easy inspection method, and it is difficult to judge easily whether or not symptoms have been developed.

On the other hand, in order to detect changes in soft tissues, recently, instead of a radiographic image, a diagnosis by the use of an image obtained by a MRI (magnetic resonance imaging) and the like has been considered. Further, recently, in radiography, a technique has been reported to extract radiant beams proceeding in parallel and radiograph cartilaginous parts with the radiant beams. However, the photography by MRI causes a heavy burden on a person to be photographed from the viewpoints of expenses and time necessary for the diagnosis. Therefore, since it may be difficult to incorporate the MRI as one item of an ordinary periodical health examination, there are problems in observing changes in joint parts such as fingers over time by conducting the MRI periodically.

Further, in order to perform radiography with radiant beams, a huge radiography facility is required. In addition, the radiography takes several tens of minutes in some cases. Therefore, it is difficult to use radiant beams in medical examinations in general medical facilities. Under the above circumstances, it has been required to make simply it possible to diagnose diseases of soft tissues, such as minute changes or swelling in joint configurations or bone geometries at an early stage.

Here, as mentioned above, in order to perform diagnosis of rheumatism diseases at an early stage, it is necessary to capture a radiation image with high sharpness to allow minute symptoms of diseased parts to be identified. As a technique capable of capturing such a radiation image with a high sharpness, for examples, Patent Document 1 discloses a technique to radiograph a phase contrast image by a radiation image radiographing apparatus. According to this technique, even for a radiographic object having a low ability of absorbing X rays so that a radiation image with a sufficient contrast cannot be captured from this radiographic object with ordinary absorption radiography, it is possible to capture an image in which the contrast of its peripheral portions (edge portions) is emphasized. Further, in addition to articular diseases represented by the above-mentioned rheumatism, the above technique can be applied to various parts, such as a breast which is organized with soft tissue in its almost all portion and for which it is required to detect calcified microscopic portions in a mammography, and a child in which almost all of bones are cartilages.

Further, as a technique to emphasize more the contrast of peripheral portions of a radiographic object, Patent Documents 2 discloses a technique to use an X-ray radiographing apparatus as a Talbot interferometer system by employing a Talbot effect by a diffraction grating.

Patent Document 1; Japanese Patent Unexamined Publication No. 2004-248699

Patent Document 2: International Patent Publication No. 2004/058070

### DISCLOSURE OF THE INVENTION

### Problems to be Solved by the Invention

However, in the Talbot interferometer system disclosed in Patent Document 2, since an X-ray source to emit radiant beams is used, a special facility is required as mentioned above. Therefore, there is a problem that the Talbot interferometer system cannot be used widely in a general medical examination facility. Further, irradiating with X-rays of low energy is assumed. This is because X-rays of low energy provide a larger effect in phase contrast and also provide a strong contrast in absorption contrast which is used in a conventional X-ray image. However, a large portion of X-rays of too low energy is absorbed by a human body and an amount of X-rays having arrived to a detector becomes small. For this reason, in order to obtain a certain amount of a SN ratio from signals in the detector, it is necessary to increase an amount of irradiated X-rays. However, this increased amount leads to increase an amount of X-rays exposed to a human body. Also, this increased amount leads to make an exposure time longer. At this time, it is difficult to keep a human body being a radiographic object from moving during the long exposure time. If the radiographic object moves, an X-ray image is captured with blurred images on peripheral portions of the radiographic object. As a result, the characteristic of the Talbot interferometer system capable of emphasizing the contrast of peripheral portions of a radiographic object, declines.

On the other hand, if the energy of irradiated X rays is too high, an irradiation time becomes short. However, it is known that the contrast of a bone, an organization of soft parts, and the like which constitute a human body is not fully acquired. If a contrast is not acquired effectively, there is a problem that an X-ray image usable for diagnosis of a human body being a photographic object is not obtained.

Therefore, when a radiation image radiographing apparatus with a Talbot interferometer system is used for a medical application, a usable range of the energy (correctly, average energy) of X rays is comparatively narrow. Further, in order to produce a Talbot effect and to realize a Talbot interferometer system, as mentioned later, there are big restrictions in a distance between a first diffraction grating and a second diffraction grating and a distance (lattice pitch) between diffractive members constituting each of the above diffraction gratings.

As mentioned above, there are expectations to apply a Talbot interferometer system to articular disease represented by rheumatism, in addition, to various parts, such as a breast which is organized with soft tissue in its almost all portion and for which it is required to detect calcified microscopic portions in a mammography, and a child in which almost all of bones are cartilages. However, in order to respond to these expectations, it is necessary to structure the Talbot interferometer system to clear the above very severe conditions.

An object of the present invention is to provide a radiation image radiographing apparatus capable of obtaining a good X-ray image in which the contrast of peripheral portions such as cartilage tissue of a human body is emphasized by a Talbot interferometer system and to provide a radiation image radiographing system to process an image captured by the radiation image radiographing apparatus.

### Means for Solving the Problems

In order to solve the problems, a radiation image radiographing apparatus described in claim 1 is provided with an X-ray tube to irradiate X rays having an average energy of 15 to 60 keV, a radiographic object board to place a photographic object thereon, a first diffraction grating to produces a Talbot effect by diffracting X rays, a second diffraction grating to diffract the X rays diffracted by the first diffraction grating, and an X-ray detector to detect the X rays diffracted by the second diffraction grating, and is characterized in that the second diffraction grating is arranged so as to come in contact with the X-ray detector, a distance between the X-ray tube and the first diffraction grating is set to 0.5 m or more, a distance between the first diffraction grating and the second diffraction grating is set to 0.05 m or more and the focal size of the X-ray tube is set to 1 μm or more.

The invention described in claim 2 is characterized in the radiation image radiographing apparatus described in claim 1 such that the radiographic object base is arranged between the X-ray tube and the first diffraction grating.

The invention described in claim 3 is characterized in the radiation image radiographing apparatus described in claim 1 such that the radiographic object base is arranged between the first diffraction grating and the second diffraction grating.

The invention described in claim 4 is characterized in the radiation image radiographing apparatus described in any one of claims 1 to 3 such that the radiation image radiographing apparatus is further provided with a control device to compare a moire stripe image having been captured before the start of an initial operation of the radiation image radiographing apparatus with a moire stripe image having been captured after the start of the initial operation so as to judge whether or not distortion takes place on the first diffraction grating and the second diffraction grating.

The invention described in claim 5 is characterized in the radiation image radiographing apparatus described in any one of claims 1 to 4 such that the radiation image radiographing apparatus is further provided with a temperature sensor to measure the temperature of the first diffraction grating and the second diffraction grating and a control device to judge whether or not the temperature of the first diffraction grating and the second diffraction grating measured by the temperature sensor is higher than a preset temperature.

The invention described in claim 6 is characterized in the radiation image radiographing apparatus described in claim 4 or 5 such that the control device conducts warning in accordance with the judgment results.

The invention described in claim 7 is characterized in the radiation image radiographing apparatus described in any one of claims 1 to 6 such that the X-ray tube, the first diffraction grating, the second diffraction grating, and the X-ray detector are adapted to rotate around a radiographic object so as to enable to radiograph the radiographic object successively from plural directions.

The invention described in claim 8 is characterized in the radiation image radiographing apparatus described in any one of claims 1 to 7 such that the first diffraction grating and the second diffraction grating are enabled to be arranged on or separated from an optical path of X-rays irradiated from the X-ray tube and the radiation image radiographing apparatus is further provided with a control device to switch over a Talbot interferometer system and a refraction contrast imaging system by controlling the first diffraction grating and the second diffraction grating to be arranged on or separated from an optical path of X-rays.

The invention described in claim 9 is characterized in the radiation image radiographing apparatus described in claim 8 such that the radiation image radiographing apparatus is further provided with a multi slit which comprises plural slits and is enabled to be arranged on or separated from an optical path of X-rays irradiated from the X-ray tube, and the control device switches over a Talbot interferometer system and a Talbot Lau interferometer system by controlling the multi slit to be arranged on or separated from an optical path of X-rays.

The invention described in claim 10 is characterized in the radiation image radiographing apparatus described in claim 8 or 9 such that the control device is constituted to detect an abnormal shade candidate from the captured X-ray image, and when the abnormal shade candidate is detected, the control device switches over from the refraction contrast imaging system to the Talbot interferometer system.

The invention described in claim 11 is directed to a radiation image radiographing system provided with the radiation image radiographing apparatus described in any one of claims 1 to 10, an image processing apparatus to process the image radiographed by the radiation image radiographing apparatus, and an image output apparatus to output the image processed by the image processing apparatus, wherein the radiation image radiographing system is characterized in that the image processing apparatus corrects X-ray image data captured by the radiation image radiographing apparatus on the condition that an radiographic object exists based on X-ray image data of a moire stripe image captured beforehand by the radiation image radiographing apparatus on the condition that a radiographic object does not exist.

The invention described in claim 12 is directed to a radiation image radiographing system provided with the radiation image radiographing apparatus described in any one of claims 7 to 10, an image processing apparatus to process the image radiographed by the radiation image radiographing apparatus, and an image output apparatus to output the image processed by the image processing apparatus, wherein the radiation image radiographing system is characterized in that the image processing apparatus forms a three-dimensional image of the radiographic object from plural images of the radiographic object radiographed successively from different directions by the radiation image radiographing apparatus and the image processing apparatus makes the image output apparatus to output the three-dimensional image.

The invention described in claim 13 is directed to a radiation image radiographing system provided with the radiation image radiographing apparatus described in any one of claims 8 to 10, and a diagnosis supporting apparatus to detect an abnormal shade candidate from X-ray image radiographed by the radiation image radiographing apparatus, wherein the radiation image radiographing system is characterized in that when the diagnosis supporting apparatus detects the abnormal shade candidate, the control device of the radiation image radiographing apparatus is switches over from the refraction contrast imaging system to the Talbot interferometer system.

### EFFECT OF THE INVENTION

According to the present invention, it becomes possible to fully exhibit a Talbot effect and to detect the configuration of a photographic object with sufficient accuracy in a moire stripe image. At this time, since X rays having an average energy of 15 to 60 keV are irradiated from the X-ray tube for a short time period of 1/several seconds or less, an X-ray image can be obtained without blurring due to motion of a human body being a photographic object and a burden to a human body can reduced. Further, with a setup to make a distance between an X-ray tube and an X-ray detector, a distance between an X-ray tube and a first diffraction grating, and the focal size of an X-ray tube appropriate respectively, it becomes possible to obtain a sufficiently clear X-ray image even with an irradiation of X rays for a short time.

Therefore, with the application of a Talbot interferometer system to various parts from which it is difficult to obtain an X-ray image by an ordinary radiation image radiographing apparatus, such as articular diseased parts represented by rheumatism, a breast which is organized with soft tissue in its almost all portion and for which it is required to detect calcified microscopic portions in a mammography, and a child in which almost all of bones are cartilages, it becomes possible to obtain a good X-ray image in which the contrast of peripheral portions of each of the various parts is emphasized.

### BRIEF DESCRIPTION OF THE DRAWING

FIG. 1 is an illustration showing an example of the entire structure of a radiation image radiographing system according to this embodiment.

FIG. 2 is a schematic view showing a structural example of a radiation image radiographing apparatus according to this embodiment.

FIG. 3 is a schematic view showing an inner structure of the radiation image radiographing apparatus shown in FIG. 2.

FIG. 4 is a perspective view of a first diffraction grating, a second diffraction grating, and a temperature sensor.

FIG. 5 is a block diagram showing a control constitution of the radiation image radiographing apparatus according to this embodiment.

FIG. 6 is a perspective view of principal parts for explaining the passing of X rays and moire stripes in the radiation image radiographing apparatus shown in FIG. 2.

FIG. 7 is a cross sectional view at I-I in FIG. 6.

FIG. 8 is a cross sectional view at II-II in FIG. 6.

FIG. 9 is an explanatory drawing for explaining positional relationships among an X-ray tube, a photographic object, a first diffraction grating, a second diffraction grating, and an X-ray detector in the radiation image radiographing apparatus shown in FIG. 2.

FIG. 10 is a schematic view showing a structural example of the radiation image radiographing apparatus constituted such that a photographic object is arranged between the first diffraction grating and the second diffraction grating.

FIG. 11 is a schematic view showing a structural example of the radiation image radiographing apparatus according to another embodiment.

FIG. 12 is a schematic view showing an inner structure of the radiation image radiographing apparatus shown in FIG. 11.

FIG. 13 is a perspective view showing the structure of a multi slit.

FIG. 14 is a perspective diagram of principal parts for explaining the passing of X-rays and moire stripes in the case that the radiation image radiographing apparatus is made into a Talbot Lau interferometer system.

FIG. 15 is an illustration for explaining the condition that the self-image of the first diffraction grating by X rays having passed through each slit of the multi slit becomes in-focus on the second diffraction grating.

FIG. 16 is an explanatory drawing for explaining positional relationships among an X-ray tube, a multi-slit, a photographic object, a first diffraction grating, a second diffraction grating, and an X-ray detector in the radiation image radiographing apparatus of a Talbot Lau interferometer system.

FIG. 17 is an illustration for explaining the outline of a refraction contrast imaging system.

FIG. 18 is an illustration for explaining the effect of a phase contrast.

FIG. 19 is a schematic view showing a structural example of the radiation image radiographing apparatus constituted such that a photographic object is arranged between the first diffraction grating and the second diffraction grating.

### EXPLANATION OF SYMBOL

1 radiation image radiographing apparatus
8 X-ray tube
15 first diffraction grating
16 second diffraction grating
15a, 16a temperature sensors
152, 162 diffractive members
17 X-ray detector
20 control device
30 image processing apparatus
50 image output apparatus
100 radiation image radiographing system
a focal size of an X-ray tube
H a photographic object
L distance between an X-ray tube and a first diffraction grating
M moire stripes
Z₁ distance between the first diffraction grating and the second diffraction grating

### BEST MODE FOR CARRYING OUT THE INVENTION

Hereafter, embodiments of a radiation image radiographing apparatus and a radiation image radiographing system according to the present invention will be described with reference to drawings. However, the scope of the invention is not limited to the examples shown in the drawings.

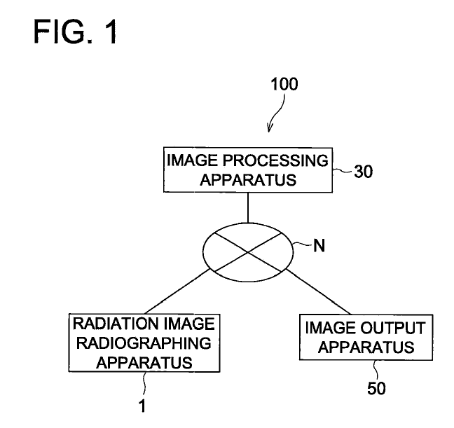

In the present embodiment, as shown in FIG. 1, a radiation image radiographing system 100 is constituted by a radiation image radiographing apparatus 1 to produce an image of a radiographic object by irradiating X rays being radiations, an image processing apparatus 30 to conduct an image processing onto the image produced by the radiation image radiographing apparatus 1, and an image output apparatuses 50 to display the image applied with the image processing by the image processing apparatus 30 or to output the image onto a film. Each apparatus is connected to a communication network N (henceforth, merely referred to “network”), such as LAN (Local Area Network), through a switching hub (not illustrated in any drawing) and the like, for example.

Here, the structure of the radiation image radiographing system 100 is not limited to what is illustrated here. For example, the radiation image radiographing system 100 is structured such that the image processing apparatus 30 and the image output apparatus 50 are integrated in one apparatus and an image processing process and an outputting process (displaying or outputting onto a film) of an image having been applied with the image processing are conducted by the one apparatus.

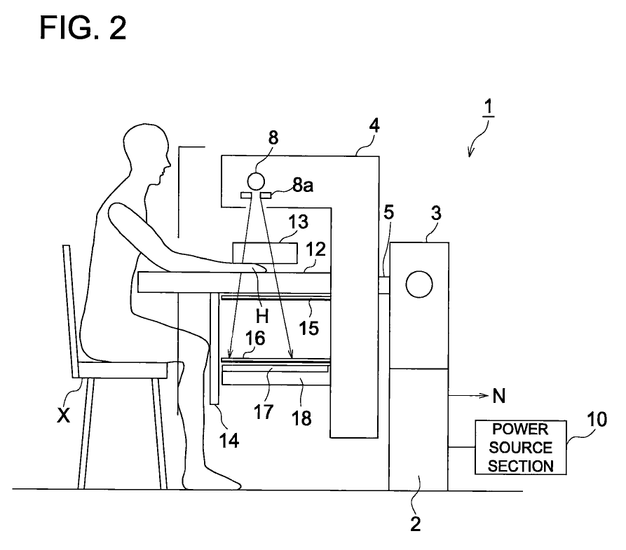

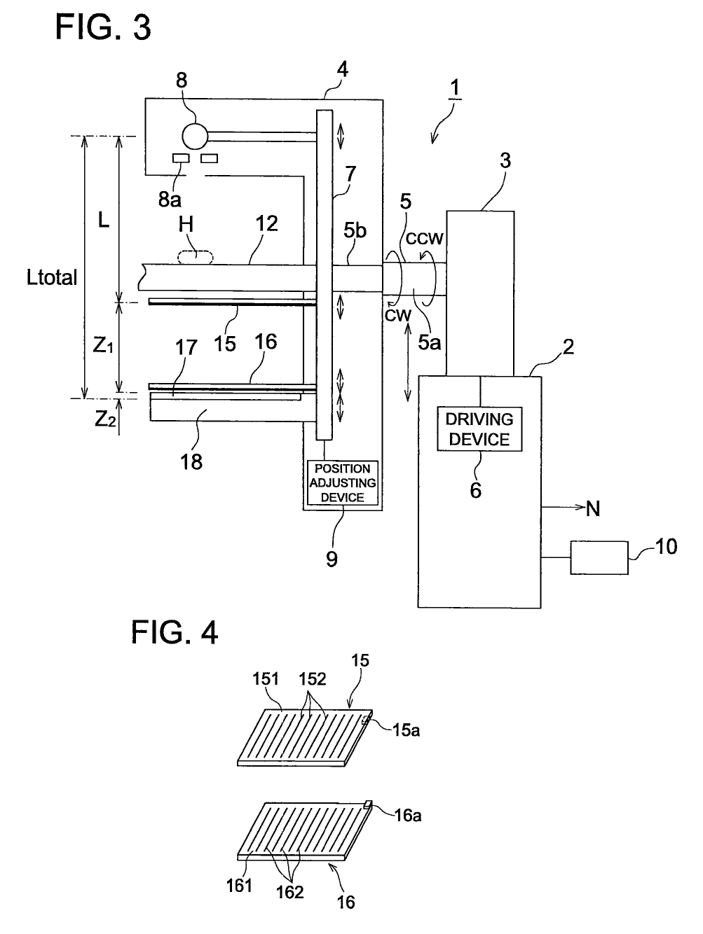

As shown in structural examples of FIGS. 2 and 3, in the radiation image radiographing apparatus 1, a supporting stay 3 is provided on a support base 2 fixed on a floor with bolts such that the supporting stay 3 can be shifted upward and downward. Onto the supporting stay 3, a radiographing apparatus main body 4 is supported through a supporting shaft 5. The supporting shaft 5 is constituted by an outer supporting sleeve 5a and an inner supporting shaft 5b provided in the outer supporting sleeve 5a, and the outer supporting sleeve 5a is adapted to rotate in the CW (clockwise) direction and the CCW (counter clockwise) direction around the inner supporting shaft 5b.

The supporting stay 3 is equipped with a drive device 6 to shift the supporting stay 3 upward and downward and to rotate the outer supporting sleeve 5a of the supporting shaft 5, and the drive device 6 is equipped with a well-known drive motor (not illustrated in drawing). The radiographing apparatus main body 4 is fixed to the outer supporting sleeve 5a and is adapted to be moved upward and downward in accordance with the upward and downward shifting of the supporting stay 3 through the supporting shaft 5. Further, when the outer supporting sleeve 5a of the supporting shaft 5 is rotated in the CW direction and the CCW direction, the radiographing apparatus main body 4 is adapted to be rotated by the supporting shaft 5 as a rotating shaft.

In the radiographing apparatus main body 4, an approximately rod-like holding member 7 is fixed so as to extend upward and downward. At an upper portion of holding member 7, an X-ray tube 8 to emit X rays toward a radiographic, object H is supported to be able to shift upward and downward. The X-ray tube 8 is shifted upward and downward by a positioning apparatus 9 equipped with a well-known drive motor (not illustrated in any drawing) so that the position of the X-ray tube 8 can be adjusted. To the X-ray tube 8, a power source section 10 to supply electric power is connected through the supporting stay 3, the supporting shaft 5, and the radiographing apparatus main body 4. Onto an X-ray emitting port of the X-ray tube 8, an aperture diaphragm 8a to adjust an X-ray irradiation field is provided so as to enable to open and close, and the aperture diaphragm 8a is adapted to shift upward and downward together with the X-ray tube 8.

As the X-ray tube 8, used is one capable of emitting X rays having an average energy of 15-60 keV. The reason is that if the average energy of the emitting X rays is less than 15 keV, since the almost large portion of the emitted X rays is absorbed by a radiographic object, the exposed dose of the radiographic object becomes very large. Accordingly, the clinical utilization of this average energy is not desirable. On the other hand, if the average energy of the emitting X rays is larger than 60 keV, since the contrast of a bone and an organization of soft parts constituting a human body cannot be obtained sufficiently, the obtained X-ray image may be unable to use for diagnosis.

As the X-ray tube 8, for example, a Coolidge X-ray tube and a rotation anode X-ray tube which are used widely at a medical site, are employed preferably. at this time, in the case that Mo (molybdenum) used for a mammography is employed as a target (anode) of an X-ray (in this case, usually, a molybdenum filter with a thickness of 30 μm is added), generally, X rays having an average energy of 15 keV are emitted under a tube voltage with a setting value of 22 kVp, and X rays having an average energy of 21 keV are emitted under a tube voltage with a setting value of 39 kVp. Further, in the case that W (tungsten) used for a general radiography is employed as a target, X rays having an average energy of 22, 32, 47, and 60 keV are usually emitted respectively under a tube voltage with respective setting values of 30, 50, 100, and 150 kVp.

In the case of the radiation image radiographing apparatus 1 intended for a radiography for articular disease represented by rheumatism like in the present embodiment, in addition, a mammography for a breast which is organized with soft tissue in its almost all portion and is required to detect calcified microscopic portions, and a radiography for articular disease in a child in which almost all of bones are cartilages, when X rays having a specifically Lau X ray energy (setting at a Lau tube voltage) among the above-mentioned X ray energy are irradiated, a sharpness of a radiation image is enhanced due to a phase contrast effect, whereby a diagnostic performance can be improved. Therefore, the average energy of irradiated X rays is preferably 15 to 32 keV, and when an exposed dose is taken into consideration, it is more desirable that the average energy is 20 to 27 keV by the use of W as a target.

Further, the focal size of the X-ray tube 8 is adapted to be set to 1 μm or more so as to enable to emit X rays having an average energy within the above-mentioned range and to obtain a practical output intensity. In order to obtain a sufficient X ray intensity, it is desirable that a focal size is 7 μm or more. Furthermore, X rays adapted to enter into a first diffraction grating mentioned later are required to have a coherency. From the points that X rays having an average energy of 15 to 60 keV are used and a distance as a radiographing apparatus described later is about 2 m as the upper limit, it is desirable that the focal size of the X-ray tube 8 is 50 μm or less in order to have such a coherency. Moreover, it is more desirable that it is 30 μm or less in order to improve a coherency and to obtain a sharp image by utilizing effectively a Talbot effect mentioned later. Here, the focal size of an X-ray tube 8 can be measured by the method specified at (2.2) Slit Camera in 7.4.1 Focal Test in JIS Z4704-1994.

If the average energy of X rays emitted from an X-ray tube 8 is within a range of 15 to 60 keV and the focal size is 1 μm or more, a time period to emit X rays for every one radiography can be set to finish about 1/several seconds or 2 to 3 or less seconds even at the longest.

Here, it is preferable for the X-ray tube 8 that the half-value width in a wavelength distribution of emitting X rays is 0.1 or less times of the peak wavelength of the emitting X rays. As long as the X-ray tube 8 satisfied such conditions, the X-ray tube 8 may not be limited to the above-mentioned Coolidge X-ray tube or rotation anode X-ray tube, but it may be a micro focus X-ray source.

Beneath the X-ray tube 8, a radiographic object board 12 for placing a photographic object H is extended from the inner supporting shaft 5b of the supporting shaft 5 in such a condition that is becomes almost parallel to a floor. The radiographic object board 12 and the inner supporting shaft 5b are not fixed to the radiographing apparatus main body 4 or the holding member 7. Therefore, as mentioned above, even though the radiographing apparatus main body 4 is rotated in the CW direction and the CCW direction by the rotation of the outer supporting sleeve 5a of the supporting shaft 5, the radiographic object board 12 is adapted to be not rotated in synchronization with the rotation of the radiographing apparatus main body 4.

However, the radiographic object board 12 is made it possible to rotate around the inner supporting shaft 5b if needed, and a radiographic object H is adapted to be pressed and fixed with a pressing plate 13 from the upper side if needed. The pressing plate 13 is supported on the radiographic object board 12 by a supporting member (not illustrated in any drawing). The pressing plate 13 can be shifted automatically or manually as an applicable selection.

The radiographic object board 12 is adapted to be shifted upward and downward in this way in accordance with the upward and downward shifting of the supporting stay 3 through the supporting shaft 5. Accordingly, the radiographic object board 12 is adjusted by the upward and downward shifting of the supporting stay 3 to such a position that a patient can take an attitude on which the patient hardly gets tired while placing an arm as a radiographic object on the radiographic object board 12. Further, beneath the radiographic object board 12, a protector 14 is provided so as to extent almost in a vertical direction in such a way that a patient sits at a radiography location without hitting legs to any obstacle. Thereby, a patient is adapted to take a radiography location while being sit on a chair X without hitting legs onto a first diffraction grating 15 mentioned later and the like and without being exposed to X rays. Here, since the pressing plate 13 and the protector 14 are not essential structural elements, the radiation image radiographing apparatus may be structured not to employ the pressing plate 13 and the protector 14.

On a central portion of the holding member 7, a first diffraction grating 15 is supported to enable to be shifted upward and downward beneath the radiographic object board 12, and on a Lauer portion of the holding member 7, a second diffraction grating 15 is supported to enable to be shifted upward and downward. The first diffraction grating 15 and the second diffraction grating 16 are held and arranged to become parallel relatively to each other. The structure of the first diffraction grating 15 and the second diffraction grating 16 and the positional relationship of them and an X-ray detector 17 mentioned later are described in detail later.

The first diffraction grating 15 is shifted upward and downward by the positioning apparatus 9 for the holding member 7 so as to adjust the distance L of the first diffraction grating 15 to the X-ray tube 8. Further, the second diffraction grating 16 is shifted upward and downward by the positioning apparatus 9 for the holding member 7 so as to adjust the distance Z₁ from the first diffraction grating 15 to the second diffraction grating 16. Here, in this embodiment, the first diffraction grating 15 and the second diffraction grating 16 are shifted upward and downward by the positioning apparatus 9 independently, respectively. Further, in the present invention, the distance between the X-ray tube 8 and other members represents the distance between the focal point of the X-ray tube 8 and other members correctly.

Moreover, as shown in FIG. 4, for example, the first diffraction grating 15 and the second diffraction grating 16 are equipped with respective temperature sensors 15a and 16a to measure the temperature of them at positions where the temperature sensors 15a and 16a are not irradiated with X rays. Here, for example, in order to make the temperature of the first diffraction grating 15 and the second diffraction grating 16 uniform at each in-plane, the first diffraction grating 15 and the second diffraction grating 16 may be pasted respectively with a heat conductor which has a good thermal conductivity and does not interrupt an X ray radiography. Further, it is also possible to heat and cool the first diffraction grating 15 and the second diffraction grating 16 with the structure that for example, the first diffraction grating 15 and the second diffraction grating 16 are provided respectively with a Peltier element capable of heating and cooling them by controlling the direction of an electrical current and the magnitude of an electrical current.

As shown in FIGS. 2 and 3, beneath the second diffraction grating 16, a detector supporting base 18 to support an X-ray detector 17 is supported to be shifted upward and downward for the holding member 7, and the detector support base 18 can be shifted upward and downward by the above-mentioned positioning apparatus 9 so that the position of the detector supporting base 18 can be adjusted independently of the first diffraction grating 15.

The X-ray detector 17 is supported on the detector supporting base 18 in such a way that the X-ray detector 17 opposes to the X-ray tube 8. In FIG. 2 and FIG. 3, in order to show that the X-ray detector 17 and the second diffraction grating 16 are separate bodies, the X-ray detector 17 and the second diffraction grating 16 are illustrated to provide a certain amount of distance Z₂ between them. However, actually, the X-ray detector 17 and the second diffraction grating 16 are arranged on the condition that they are brought in contact with each other. The reason is that if the second diffraction grating 16 is distant more from the X-ray detector 17, a moire stripes becomes obscure more. That is, the X-ray detector 17 and the second diffraction grating 16 are arranged so that the distance Z₂ in FIG. 3 becomes almost 0. Here, it is also possible to constitute the second diffraction grating 16 and X-ray detector 17 in an integrated structure. Moreover, beneath the X-ray detector 17 or inside the detector supporting base 18, a radiation shield member (not illustrated in any drawing) is provided in order to prevent a human body existing under the X-ray detector 17 from being exposed to an X-ray irradiation.

The X-ray detector 17 is constituted to be connected with a panel, a detector control section and the like (not illustrated in any drawing) through bus lines. Further, the X-ray detector 17 is adapted to detect an amount of X-rays which has been emitted from X-ray tube 8 and has passed though a radiographic object H, and the X-ray detector 17 outputs the detected amount of X-rays as X-ray image data to the image processing apparatus 30 through a Network N (refer to FIG. 1).

As the X-ray detector 17, a FPD (Flat Panel Detector) to detect an amount of X rays as digital information for every pixel and a CR (Computed Radiography), a detector employing a CCD (Charge Coupled Device) are used preferably. However, the FPD excellent as a two-dimensional image sensor is especially desirable. A pixel size is preferably 10 to 200 μm, and more preferably 50 to 150 μm. The size of the whole panel can be chosen suitably.

The X-ray detector 17 is set such that the distance Ltotal between itself and the X-ray tube 8 becomes 0.5 m or more, and the upper limit of the distance Ltotal is set to about 2 m in consideration of accuracy and intensity of the radiation image radiographing apparatus 1 and a restriction in using the radiation image radiographing apparatus 1 in a room.

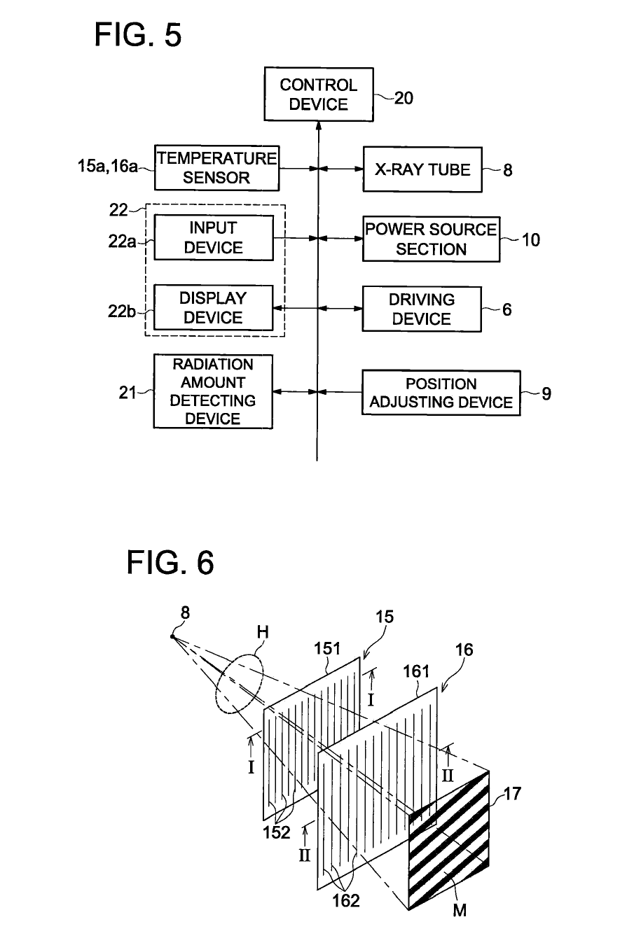

Various kinds of set-up for the radiation image radiographing apparatus 1 and a control for the set-up operation are conducted by a control device 20 shown in FIG. 5. The control device 20 is constituted by a computer in which a CPU (Central Processing Unit) (not illustrated in any drawing), a ROM (Read Only Memory), a RAM (Random Access Memory) and the like are connected by bus lines.

Although it is also possible to install the control device 20 in the same room in which the radiation image radiographing apparatus 1 is installed, in this embodiment, the control device 20 is established by the use a computer constituting the image processing apparatus 30 being connected to the radiation image radiographing apparatus 1 through the network N. That is, the control device 20 and the image processing apparatus 30 are constituted by the use of the same computer. Here, it is possible to constitute the control device 20 in a separate computer from the image processing apparatus 30 being connected through the network N.

As shown in FIG. 5, the control device 20 is connected to the above-mentioned X-ray tube 8, the power source section 10, the driving unit 6, the positioning (position adjusting) apparatus 9 and the temperature sensors 15a and 16a, in addition, to a radiation amount detecting device 21 to detect an amount of irradiated X-rays and an operating device 22 equipped with an input device 22a and a display device 22b.

In a memory, such as a ROM of the control device 20, control programs and various processing programs to control each section of the radiation image radiographing apparatus 1 are memorized. The control device 20 reads the control programs and the various processing programs from the memory based on an input inputted from input devices 22a such as a keyboard, a mouse, and a controller by an operator. The control device 20 is adapted to control the operation of each section of the radiation image radiographing apparatus 1 in an overall control manner while displaying a control content on a display devices 22b, such as a CRT display monitor and a liquid crystal display.

For example, if a tube voltage of the used X-ray tube 8 is set up as mentioned above, the average energy of X rays irradiated from the X-ray tube 8 is determined, and then in accordance with the average energy, an allowable range of the distance L between the X-ray tube 8 and the first diffraction grating 15 and the distance Z₁ between the first diffraction grating 15 and the second diffraction grating 16 are determined. Further, as mentioned above, in the case that the second diffraction grating 16 and the X-ray detector 17 are brought in close contact with each other, in FIG. 2, if temporarily a distance from the X-ray tube 8 to the radiographic object board 12 is R1 and a distance from the radiographic object board 12 to the X-ray detector 17 is R2, an enlarging ratio of a photographic object H is determined by a formula of ((R1+R2)/R1) depending on the position of the radiographic object board 12.

Then, in this embodiment, if the tube voltage of the X-ray tube 8, the distance L, the distance Z₁, the enlarging ratio, and the like are inputted through the input device 22a, the control device 20 drives the positioning apparatus 9 based on these inputted values to conduct positioning for the X-ray tube 8, the first diffraction grating 15, the second diffraction grating 16, and the X-ray detector 17 for the radiographic object board 12. And then, a positioning is conducted to shift the supporting stay 3 upward or downward so as to shift the radiographic object board 12 upward or downward while keeping the positional relationship among the above members in such a way that a patient can take an attitude with which the patient gets hardly tired.

Here, since the positioning must be conducted in such a way that the radiographic object board 12 is not brought in contact with the first diffraction grating 15, there is a limitation in each of the above mentioned distances R1 and R2. Therefore, a range capable of setting up an enlarging ratio ((R1+R2)/R1) is restricted. Therefore, it is also possible to constitute such that a range capable of setting up an enlarging ratio may be displayed on a display device 22b at the stage when the tube voltage of the X-ray tube 8, the distance L, the distance Z₁, and an enlarging ratio are inputted.

Moreover, it is also possible to constitute such that a LUT (Look-up Table) to indicate a distance L and a distance Z₁ suitable for a tube voltage of a used X-ray tube 8 is prepared beforehand, and when a tube voltage is inputted, a distance L and a distance Z₁ are set up automatically. In this case, when a tube voltage is inputted, positioning is conducted automatically for the X-ray tube 8, the first diffraction grating 15, the second diffraction grating 16, and the X-ray detector 17, and further, when an enlarging ratio is inputted, positioning between the above members and the radiographic object board 12 is performed in accordance with the enlarging ratio.

In addition to the positioning for the X-ray tube 8 and the like in the above manner, the control device 20 drives the driving device 6 to rotate the supporting shaft 5 in the CW direction or the CCW direction shown in FIG. 3 so that the radiographing apparatus main body 4 is rotated around a radiographic object H, whereby a radiation irradiation angle is adjusted.

Moreover, at the time that the radiation image radiographing apparatus 1 works, the control device 20 supplies an electric power from the power source section 10 to the X-ray tube 8, and makes the X-ray tube 8 to emit X rays to a radiographic object H. At this time, if an amount of X-rays detected by the X-ray amount detecting device 21 reaches a predetermined X-ray amount set up beforehand, the control device 20 stops the supply of the electric power from the power source section 10 to the X-ray tube 8, whereby the X-ray tube 8 stops emitting X rays. Here, the emitting conditions of X rays are set up suitably in the light of factors other than an amount of X-rays detected by the radiation amount detecting device 21, namely, such as the kind of the X-ray detector 17.

In this embodiment, the control device 20 drives the drive unit 6 to rotate the supporting shaft 5 so as to rotate the radiographing apparatus main body 4 in such a way that the X-ray tube 8, the first diffraction grating 15, the second diffraction grating 16, and the X-ray detector 17 are rotated around a radiographic object H, whereby the radiographic object H is irradiated with X rays from plural directions and radiation images of the radiographic object H can be taken successively. Here, an amount of rotation of the radiographing apparatus main body 4 and a radiographic timing (a timing to take a radiation image for each of some degrees of rotation angles) are set up by being inputted from the input device 22a.

Furthermore, the temperature of each of the first diffraction grating 15 and the second diffraction grating 16 is measured by the corresponding temperature sensors 15a and 16a arranged on the first diffraction grating 15 and the second diffraction grating 16, and the control device 20 is adapted to judges whether or not the measured temperature is equal to or higher than the temperature set beforehand. In this embodiment, in the case that at least one side of the temperature of the first diffraction grating 15 and the temperature of the second diffraction grating 16 is equal to or higher than the temperature set beforehand, the control device 20 is adapted to conduct warning. As to the warning, the control device 20 controls a display device 22b to indicate warning visually or to sound warning auditory.

Here, in the case that the first diffraction grating 15 and the second diffraction grating 16 are provided respectively with a Peltier element capable of conducting heating and cooling by controlling the direction of an electrical current and the magnitude of an electrical current, when the temperature of the first diffraction grating 15 and the second diffraction grating 16 measured by the temperature sensors 15a and 16a becomes high or Lau, it is possible to control such that the Peltier device is operated to make the temperature of the first diffraction grating 15 and the second diffraction grating 16 within a predetermined temperature range.

In this embodiment, further, on the basis of a moire stripe image (refer to moire stripes M shown in FIG. 6 mentioned later) detected on the condition that a radiographic object H is not placed on the radiographic object board 12 as mentioned later, the control device 20 is constituted to judge whether or not a distortion due to temperature or a distortion over time takes place on the first diffraction grating 15 or the second diffraction grating 16.

Concretely, at a stage when the radiation image radiographing apparatus 1 was shipped from a factory and was installed in a room or at a stage when the first diffraction grating 15 and the second diffraction grating 16 were exchanged with another one, the control device 20 control to take a moire stripe image on the condition that a radiographic object H is not placed on the radiographic object board 12 before the start of working of an apparatus and memorizes the moire stripe image in a memory, such as a RAM. And then, at the stage when the conditions set up beforehand are satisfied, for example, when the working hour of the radiation image radiographing apparatus 1 exceeds a preset working hour or when the number of times of irradiating X rays becomes the predetermined number of times, the control device 20 controls again to take a moire stripe image on the condition that a radiographic object H is not placed on the radiographic object board 12. It may be structured that a moire stripe image is taken periodically.

And then, the control device 20 reads the moire stripe image having been taken before the start of working of the apparatus from the memory, and the control device 20 conducts comparison between the moire stripe image having been taken at this time and the moire stripe image having been taken before the start of working of the apparatus. As a result, as compared with the moire stripe image having been taken before the start of working of the apparatus, in the moire stripe image having been taken at this time, in the case that a distance between moire stripes is enlarged or reduced by a predetermined amount or more, moire stripes are curved partially or entirely, and a difference in detected amount between a part irradiated with a maximum amount of X-rays and a part irradiated with a minimum amount of X-rays among moire stripes is enlarged or reduced by a predetermined amount or more, the control device 20 is adapted to judge such that distortion takes place on diffractive members (grating) of the first diffraction grating 15 or the second diffraction grating 16. Here, in the embodiment in which a Talbot interferometer system, a Talbot Lau interferometer system and a refraction contrast imaging system can be switched from each other, the above operation may be conducted in any one system or all the systems of the Talbot interferometer system, the Talbot Lau interferometer system and the refraction contrast imaging system.

When the control device 20 judges in this way such that distortion takes place on the diffractive members of the first diffraction grating 15 or the second diffraction grating 16, the control device 20 controls a display device 22b to indicate warning visually or to sound warning auditory in the same way mentioned above.

The image processing apparatus 30 and the image output apparatus 50 are connected to the radiation image radiographing apparatus 1 in the network N as shown in FIG. 1. The image output apparatus 50 includes a display device such as a CRT display monitor and a liquid crystal display and a developing device to output images on a film.

When the image processing apparatus 30 receives x-ray image data in the form of pixels transmitted from the X-ray detector 17 of the radiation image radiographing apparatus 1 through the network N, the image processing apparatus 30 is adapted to store temporarily the received X-ray image data in a memory (not illustrated in any drawing). As the memory, employed is a hard disk array such as a hard disk and a RAID (Redundant Array of Independent Disks), and a silicon disc which are a large and high-speed memory device.

Moreover, the image processing apparatus 30 is adapted to make the radiation image radiographing apparatus 1 to take a moire stripe image beforehand on the condition that a photographic object H does not exist, to make the radiation image radiographing apparatus 1 to transmit X-ray image data of the moire stripe image, and to memorize the X-ray image data in a memory. This X-ray image data are deemed temporarily as reference X-ray image data. And, when a radiographic operation for a radiographic object H is started by the radiation image radiographing apparatus 1, the image processing system 30 is adapted to receive X-ray image data of the radiographic object H taken and transmitted by the radiation image radiographing apparatus 1 and to correct the X-ray image data based on the reference X-ray image data.

The correction is conducted, for example, for positional deviations, sensibility unevenness (namely, non-uniformity of signal value of a detector), and the like on an image. That is, when it turns out from the reference X-ray image data that positional deviations take place on a specific pixel region on an image, the positional deviations can be corrected by the correction in such a way that the positions of pixels on the specific pixel region of the transmitted X-ray image data are shifted back to the original positions by the distances of the positional deviations. Moreover, by a calculation of dividing the X-ray image data after the correction of positional deviations for each pixel by the reference X-ray image data, an X-ray image with no sensibility unevenness due to the existence of a diffraction grating can be obtained. The image processing apparatus 30 is adapted to also store the X-ray image data having been processed in this way in a memory.

Moreover, the image processing apparatus 30 is adapted to be able to conduct a conversion to convert from X-ray image (moire stripe image) detected by the X-ray detector 17 to a distribution image (phase shift differential image) with an angle at which X rays are bent by an refraction effect due to a radiographic object H and an acquisition of an image showing a phase shift itself due to a calculation of integrating a phase shift differential image. For the above conversion and the acquisition of an image, well-known methods, such as a method disclosed in the International Publication No. 2004/058070 and the like are used.

Further, in this embodiment, when the image radiation image radiographing apparatus 1 takes plural sets of X-ray image data from a radiographic object H successively with different photographic directions and transmits the plural sets of X-ray image data, the image processing system 30 is adapted to form a three dimensional image of the radiographic object H based on the plural sets of X-ray image data. The image output apparatus 50 outputs the formed three dimensional image by indicating it on a liquid crystal display or by outputting it on a film. Here, as a method of forming a three dimensional image from plural sets of two dimensional image data taken from a radiographic object H, well-known methods can be used.

Here, it is also possible to apply further treatments to a two dimensional image and a three dimensional image of a radiographic object H obtained in the above ways. For example, a treatment to reverse the brightness of an image whose cartilage part is outputted with a dark color for a light color of a background, or a treatment to apply a color for a portion which changes greatly from the model of a standard cartilage part is applied to an image and the applied image is displayed or outputted on a film, whereby it becomes possible to obtain an image with an emphasized portion in which some symptom has appeared. Further, for example, in the case that the symptom of rheumatism has appeared in fingers of a hand, it becomes possible to observe affected parts with dynamic image by obtaining plural three dimensional images in which an observing angle of joints of fingers is changed variously.

Here, in the embodiment in which a Talbot interferometer system, a Talbot Lau interferometer system and a refraction contrast imaging system can be switched from each other, the above operation may be conducted in any one system or all the systems of the Talbot interferometer system, the Talbot Lau interferometer system and the refraction contrast imaging system.

Next, a Talbot interferometer constituted in the radiation image radiographing apparatus 1 of this embodiment is explained, and the action of the radiation image radiographing apparatus 1 is explained in combination with the explanation of the structure of the first diffraction grating 15 and the second diffraction grating 16 and the positional relationship among the X-ray detector 17 and them.

In this embodiment, as shown in FIG. 6, X-rays are emitted from the X-ray tube 8 and passes through a radiographic object H. Then, the X-rays passes through the first diffraction grating 15 and the second diffraction grating 16, and enters into the X-ray detector 17. A Talbot interferometer is constituted by the X-ray tube 8, the first diffraction grating 15, and the second diffraction grating 16.

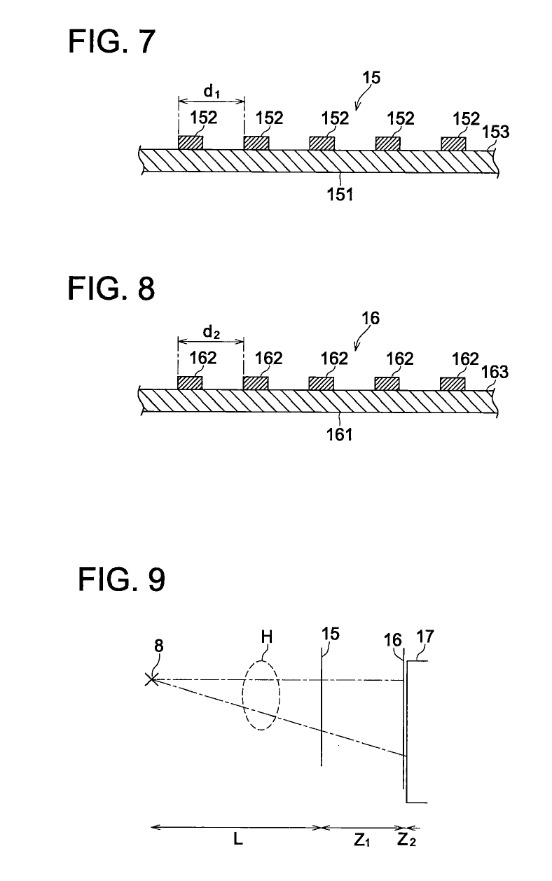

FIG. 7 is a I-I cross sectional view in FIG. 6. As shown in FIGS. 6 and 7, the first diffraction grating 15 is equipped with a substrate 151 and plural diffractive members 152 arranged on this substrate 151, and the first diffraction grating 15 produces a Talbot effect mentioned later by diffracting irradiated X rays having passed through the radiographic object board 12 and the radiographic object H supported on the radiographic object board 12. The substrate 151 is formed, for example, by glass and the like. Here, a surface of the substrate 151 where the diffractive members 152 are arranged is named a diffraction grating surface 153.

Plural diffractive members 152 are linear members extending in one direction perpendicular to a irradiating direction of X-rays irradiated from the X-ray tube 8, that is, for example, in a vertical direction in FIG. 6. Each of the diffractive members 152 has an almost equal thickness, for example, is formed with a thickness of 10 to 50 μm.

Further, as shown in FIG. 7, it is supposed that a distance d₁ between the plural diffractive members 152s is constant, and a distance between the diffractive members 152 is made into an equal distance. The distance d₁ is made to about 3 to 10 μm. The distance d₁ is also called a lattice pitch and a grid interval. Here, the distance d₁ between the plural diffractive members 152 and the width of each of the diffractive members 152 are not limited specifically. The distance d₁ between the plural diffractive members 152 and the width of each of the diffractive members 152 are made equal or different among the plural diffractive members 152.

As a material constituting the plural diffractive members 152, a material excellent in X-ray absorbing ability is desirable, for example, metals, such as gold, silver, and platinum can be employed. The diffractive members 152 can be formed by, for example, a process of plating or vapor-depositing such a metal on the substrate 151. The diffractive members 152 are used to change a phase speed of X rays irradiated to the diffractive members 152. As the diffractive members 152, diffractive members are desirable to form a so-called phase type diffraction grating capable of providing a phase modulation of about 80° to 100°, preferably 90° to irradiated X rays. X rays do not necessarily need to be monochrome and may have an energy width (that is, wavelength spectrum width) in a range satisfying the above-mentioned conditions.

FIG. 8 is a II-II cross sectional view in FIG. 6. As shown in FIGS. 6 and 8, the second diffraction grating 16 is equipped with a substrate 161 and plural diffractive members 162 as with the first diffraction grating 15. Here, the surface of the substrate 161 where the diffractive members 162 are arranged is named a diffraction grating surface 163.

Here, a distance d₂ between diffractive members 162 of the second diffraction grating 16 is constituted such that a ratio of a distance L+Z₁ from the X-ray tube 8 to the second diffraction grating 16 to the distance d₂ may become almost equal to a ratio of a distance L from the X-ray tube 8 to the first diffraction grating 15 to the distance d₁ in the first diffraction grating 15. Further, it is also possible to constitute the distance d₂ between the diffractive-members 162 of the second diffraction grating 16 to become, for example, the same as the distance d₁ between the diffractive members 152 of the first diffraction grating 15. Furthermore, the width of each of the diffractive members 162 of the second diffraction grating 16 is the same as the width of each of the diffractive members 152 of the first diffraction grating 15.

The second diffraction grating 16 is arranged on the condition that the extending direction of the diffractive members 162 is rotated by only a minute angle θ relatively to the extending direction of the diffractive members 152 of the first diffraction grating 15 as mentioned later, whereby the second diffraction grating 16 is structured to form image contrast by diffracting X rays diffracted by the first diffraction grating 15. The second diffraction grating 16 is desirably an amplitude type diffraction grating in which the diffractive members 162 are made thicker. However, it is also possible to structure the second diffraction grating 16 as with the first diffraction grating 15.

Next, the condition to form a Talbot interferometer by the X-ray tube 8, the first diffraction grating 15, and the second diffraction grating 16 will be explained.

The distance Z₁ between the first diffraction grating 15 and the second diffraction grating 16 must satisfy the following condition mostly with the presupposition that the first diffraction grating 15 is a phase type diffraction grating. In the formula, m is an integer, and d₁ is the above mentioned distance between the diffractive members 152 of the first diffraction grating 15.

$$\begin{matrix}Formula ( 1 ) & \\ {Z}_{1} = ( m + \frac{1}{2} ) \frac{{d}_{1}^{2}}{λ} & ( 1 )\end{matrix}$$

A Talbot effect will be explained with reference to FIG. 9. In the case that the first diffraction grating 15 is a phase type diffraction grating, when a plane wave of X rays passes through the first diffraction grating 15, a self-image of a diffraction grating is formed at the distance given by Formula (1) by the Talbot effect. On the condition that a radiographic object H does not exist, a self-image of the first diffraction grating 15, that is, an image of the diffractive members 152 in which a lattice pitch for every distance d₁ is slightly enlarged, appears at a position separated from the first diffraction grating 15 by a distance Z₁ given by Formula (1).

Here, at positions other than the distance Z₁ given by Formula (1), a self-image is not visible or becomes an obscure image being out of the focus. However, at positions near the distance Z₁ given by Formula (1), an image is comparatively maintained on an in-focus condition. Therefore, hereafter, in the case of designating a distance Z₁ given by Formula (1), a distance neighboring the distance Z₁ is also included. Further, in the setup of an actual distance Z₁, a play from the distance Z₁ given by Formula (1) is permitted.

And, if the second diffraction grating 16 is placed at a position of the distance Z₁ given by Formula (1) on the condition that the extending direction of the diffractive member 162 is rotated by only a minute angle θ relatively to the extending direction of the diffractive member 152 of the first diffraction grating 15, moire stripes appear and a moire stripe image in which moire stripes M as shown in FIG. 6 are mirrored is detected by the X-ray detector 17. In this case, a distance between generated moire stripes M is given by d₁/θ from the distance d₁ between the diffractive members 152 and the relative minute angle θ.

On the other hand, when a radiographic object H exists between the X-ray tube 8 and the first diffraction grating 15, since the phase of X rays irradiated from the X-ray tube 8 is deviated by the radiographic object H while the X rays pass through the radiographic object H, the wave front of the X rays entering into the first diffraction grating 15 becomes distorted. Therefore, the self-image of the first diffraction grating 15 deforms depending on it.

And, when the X rays having been diffracted by the first diffraction grating 15 has passed through the second diffraction grating 16, according to the distortion of the wave front of the X rays, moire stripes M also become distorted according to the shape of the radiographic object H. At this time, since the X rays passes through the inner portion of the radiographic object H, the X rays become distorted also in accordance with the shape of the inner portion of the radiographic object H, the distortion of them is mirrored in the moire stripes M.

Further, at this time, the distortion due to the radiographic object H is actually reflected also on the self-image of the first diffraction grating 15. Therefore, the condition at the position of the distance Z₁ given by Formula (1) becomes such that the shapes of the radiographic object H and its inner portion are reflected into the diffractive stripes of the diffractive members 152 in which the lattice pitch for each of the distance d₁ became a slightly expanded distance. However, these diffractive stripes cannot be detected by a resolving power of an ordinary X-ray detector 17. Therefore, since the distortion of the diffractive stripes due to the radiographic object H is also not detected, it is difficult to obtain an X-ray image of the photographic object H if nothing is done.

However, if the structure is made such that the second diffraction grating 16 is rotated relatively to the first diffraction grating 15 by a minute angle θ so as to form a moire stripe image in which the distance between stripes is remarkably larger than a lattice pitch, these moire stripes M can be detected even by the resolving power of an ordinary X-ray detector 17. And, since moire stripes M distorted in accordance with the shape of a radiographic object H and its inner portion can be detected by the use of an ordinary X-ray detector 17, it becomes possible to obtain an X-ray image of an radiographic object H in which the shape of the radiographic object H and its inner portion are mirrored.

In the radiation image radiographing apparatus 1 of this embodiment employing the above mentioned Talbot interferometers, in order to enhance coherence at the time that the above mentioned X rays irradiated from the X-ray tube 8 and having an average energy of 15 to 60 keV enter into the first diffraction grating 15, it is necessary to make a distance L between the X-ray tube 8 and the first diffraction grating 15 more than a prescribed distance.

As mentioned above, in the case that the focal size “a” of the X-ray tube 8 is 1 μm being minimum and the average energy of X rays is 60 keV being the highest, the distance L between the X-ray tube 8 and the first diffraction grating 15 is needed to be 0.5 m or more. However, a coherency (coherence length) is proportional to the distance L and is inversely proportional to the average energy of X rays and the focal size. Therefore, in the case that a coherency is acquired with X rays having an average energy of 60 keV, for example, when the average energy of X rays is 15 keV, even if the distance L between the X-ray tube 8 and the first diffraction grating 15 is made 0.125 m (12.5 cm) or more, or the focal size “a” of the X-ray tube 8 is expanded to 4 μm, the equivalent coherency can be acquired.

Further, although the distance Z₁ between the first diffraction grating 15 and the second diffraction grating 16 is given by the formula (1), as it can be understood from that the wave length λ of X rays resides in Formula (1), the distance Z₁ depends on the average energy of the X rays irradiated from the X-ray tube 8. Therefore, as mentioned above, in the case that the distance d₁ the between diffractive members 152 of the first diffraction grating 15 is made to about 3 μm being producible technically and the average energy of irradiated X rays is in a range of 15 to 60 keV, the distance Z₁ between the first diffraction grating 15 and the second diffraction grating 16 is needed to be 0.05 m or more.

Here, the Lauer limit of an available range of the distance Ltotal from the X-ray tube 8 to the X-ray detector 17 is specified by the limitation of the distance L and the distance Z₁ (the distance Z₂ from the second diffraction grating 16 to the X-ray detector 17 is 0) as mentioned above. Further, although an upper limit is not limited specifically, if it is taken into consideration to use the radiation image radiographing apparatus 1 of this embodiment in a room, the upper limit may be about 2 m.

As mentioned above, according to the radiation image radiographing apparatus 1 related to this embodiment, in the case that the apparatus is used for medical application, it is allowed to irradiate only with X rays in a relatively narrow range of 15 to 60 keV in average energy. However, in such a case, with a structure in which the second diffraction grating 16 is arranged to come in contact with the X-ray detector 17, and the distance L between the X-ray tube 8 and the first diffraction grating 15, the distance Z₁ between the first diffraction grating 15 and the second diffraction grating 16 and the focal size “a” of the X-ray tube 8 are determined as mentioned above, it becomes possible to fully exhibit a Talbot effect, whereby the shape of the radiographic object H and its inner portion can be detected in a moire stripe image with sufficient accuracy.

Further, if the average energy of irradiated X rays is less than 15 keV, the almost large portion of the irradiated X rays is absorbed in a radiographic object. Therefore, since the exposed dose of a photographic object becomes very large, it is not desirable in the point of clinical utilization. However, when the average energy of irradiated X rays is made 15 keV or more, such a problem can be avoided. In addition, since irradiation of X rays for every one radiography can be completed within about 1/several seconds or 2 to 3 or seconds or less even if long, it becomes possible to obtain an X-ray image without blurring due to movement of a human body being a radiographic object H. Further, when the average energy of irradiated X rays is made 60 keV or less, the contrast of a bone and an organization of soft parts constituting a human body is acquired sufficiently.

Accordingly, for articular disease represented by rheumatism, in addition, even for articular disease in an organization part from which it is difficult to obtain an X-ray image with an ordinary X-ray radiographing apparatus, such as in abreast which is organized with soft tissue in its almost all portion and is required to detect calcified microscopic portions, and in a child in which almost all of bones are cartilages, it becomes possible to obtain a good X-ray image in which the contrast of a peripheral portion is emphasized with the use of the Talbot interferometer system, whereby it becomes possible to use the thus acquired X-ray image with clear contrast for diagnosis effectively.

Moreover, with an image processing appropriately conducted by the image processing apparatus 30 of the radiation image radiography system 100, a clearer X image can be obtained. Further, it becomes possible to obtain a three dimensional image of a radiographic object H and an image with an emphasized portion in which some symptom has appeared.

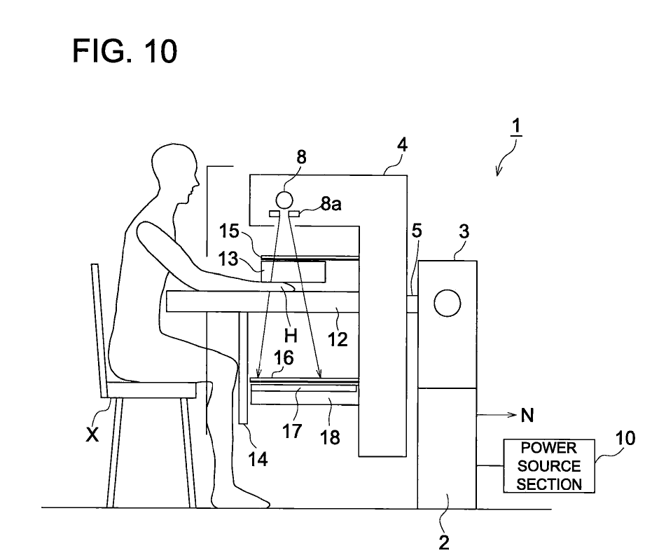

Here, instead of constituting such that a radiographic object H (radiographic object board 12) is placed between the X-ray tube 8 and the first diffraction grating 15 as with the radiation image radiographing apparatus 1 according to this embodiment shown in FIG. 2, it is also possible to constitute such that, for example, a radiographic object H is arranged between the first diffraction grating 15 and the second diffraction grating 16a as with a radiation image radiographing apparatus shown in FIG. 10.

In this embodiment, as shown in FIG. 10, X rays are irradiated from the X-ray tube 8 and pass through the first diffraction grating 15. Then, the X rays pass through a radiographic object H and the second diffraction grating 16, and enter into X-ray detector 17. With this arrangement, a Talbot interferometer is constituted by the X-ray tube 8, the first diffraction grating 15, and the second diffraction grating 16.

Further, since the first diffraction grating 15 is arranged between the X-ray tube 8 and a radiographic object H, as compared with the case where a radiographic object H is inserted between the X-ray tube 8 and the first diffraction grating 15, it becomes possible to make the first diffraction grating 15 with a more small area. Accordingly, the first diffraction grating 15 can be produced easily. Furthermore, at the same time, the influence of blurring of an X-ray image caused by unevenness in the manufacture of the diffractive members 152 can be reduced, and it becomes possible to obtain a higher resolution X-ray image.

### Another Embodiment

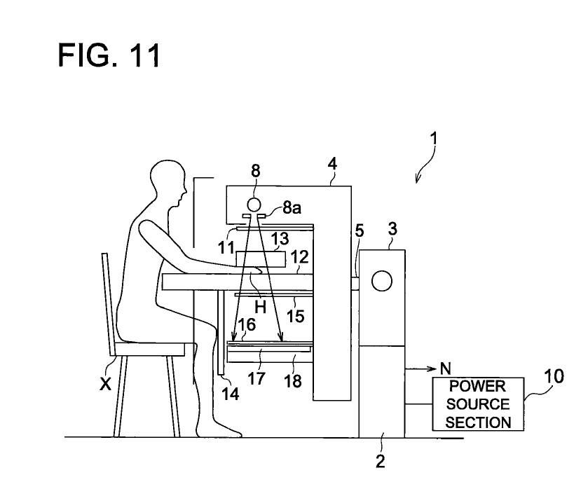

Another embodiment will be described with reference to FIGS. 11 through 19. The radiation image radiographing apparatus 1 of the radiation image radiographing system shown in these figures is adapted to switch over the Talbot interferometer system, the Talbot Lau interferometer system, and the refraction contrast imaging system. Matters in this embodiment are common to those in the radiation image radiographing system explained in FIGS. 1 through 10 except the matters shown in these figures, and the explanation for the matters is omitted.

In the case that the radiation image radiographing apparatus 1 is used as a Talbot Lau interferometer system, X rays entering into the first diffraction grating are required to have a coherency. In order to have a coherence, it is desirable for the focal size of the X-ray tube 8 to be more small. In the present invention, X rays irradiated from the X-ray tube 8 are made into multi light sources by multi slits 11 mentioned later. Therefore, since the X-ray tube 8 is required to have a high output, it is not necessary to make the focal size of the X-ray tube 8 so small. Then, in this embodiment, the focal size of the X-ray tube 8 is set 100 μm or more. Concretely, the focal size of the X-ray tube 8 is preferably 100 to 2000 μm, and more preferably 300 μm or more. For practical purposes, a focal size of 600 to 1200 μm is adopted preferably.

And, when the radiation image radiographing apparatus 1 is used as a refraction contrast imaging system, the focal size of X-ray tube 8 is preferably 30 to 200 μm.

In this embodiment, the switching-over of the focal size of X-ray tube 8 is conducted by a control device to change the angle of a target of an X-ray tube as mentioned later. As a method of changing the angle of a target, there are a method of changing the angle by slanting a target and a method of changing the angle by changing a position of a target to be irradiated with electron beams in which the target is produced beforehand so as to have two angles. In addition, there is a method of changing a focal size by changing a region of electron beams irradiated onto a target. Further, it is also possible to constitute such that the radiation image radiographing apparatus 1 is provided with plural X-ray tubes having respective different focal sizes, and at the time of switching over a Talbot interferometer system, a Talbot Lau interferometer system, and a refraction contrast imaging system, the X-ray tube 8 itself is exchanged for another one.

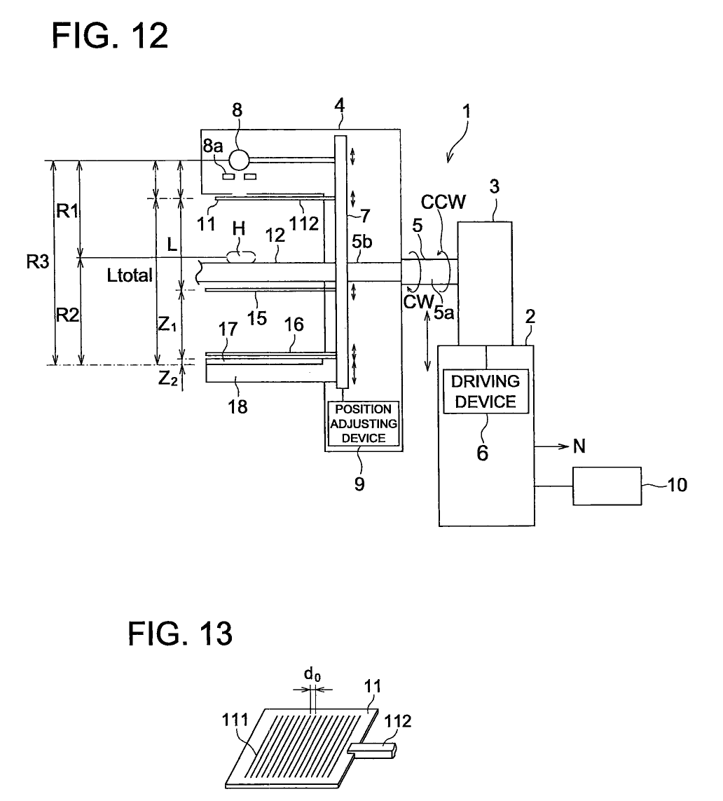

Beneath the X-ray tube 8, as shown in FIGS. 11 and 12, a multi slit 11 is arranged. In the case that the radiation image radiographing apparatus 1 is used as a Talbot Lau interferometer system, the multi slit 11 is arranged on an optical path of X rays having been irradiated from the X-ray tube 8. In the case that the radiation image radiographing apparatus 1 is used as a Talbot interferometer system, the multi slit 11 is separated from on the optical path.

As shown in FIG. 13, the multi slit 11 is constituted by a thin plate on which plural slits 111 are provided so as become parallel to each other. The thin plate is made of a material to shelter X rays (with a large absorbing ability for X rays), such as lead and tungsten. Further, the width of an opening section of each slit 111 (namely, so-called slit width) is preferably shaped in about 1 to 50 μm, and more preferably about 7 to 30 μm in order to utilize a Talbot effect effectively and obtain a sufficient amount of X-rays. With this, X rays entering into the first diffraction grating mentioned later are made into multi light sources while becoming to have a coherency. Here, the distance d0 between slits 111 of the multi slit 11 is mentioned later.

Further, the plural slits 111 of the multi slit 11 are formed only in the irradiation field of X rays irradiated from the X-ray tube 8. As shown in FIG. 12, the multi slit 11 is supported by the holding member 7 through a supporting member 112 so as to be shifted upward and downward, and the position of the multi slit 11 is adjusted by the positioning apparatus 9 by being shifted upward and downward along with the holding member 7.

In this embodiment, the multi-slit 11 is adapted to rotate around the shaft of the holding member 7 by being driven by the positioning apparatus 9. In the case that the radiation image radiographing apparatus 1 is used as a Talbot interferometer system, the multi slit 11 is rotated around the holding member 7 so that the multi slit 11 is separated from the optical path. On the other hand, in the case that the radiation image radiographing apparatus 1 is used as a Talbot Lau interferometer system, the multi slit 11 is rotated around the holding member 7 so that the multi slit 11 is arranged on the optical path.

Here, it is also possible to make other driving units to conduct this rotational operation, or to conduct this rotational operation manually. Further, in addition, it is also possible to constitute such that, for example, a connecting section between the multi slit 11 and the holding member 7 is structured to be retractable. Therefore, the multi slit 11 is shifted toward the holding member 7 or shifted to be separated from the holding member 7 so that the multi slit 11 is arranged on the optical path of X rays or separated from the optical path.

In the case that the multi-slit 11 is arranged on the optical path of X rays, the extending direction of plural slits 111 is arranged to become parallel to the extending direction of the diffractive members 152 of the first diffraction grating 15 mentioned later. Further, as shown in FIG. 11, since X rays irradiated from X-ray tube 8 is spreading as the X rays is separating from the X-ray tube 8, if the multi slit 11 is arranged on a position distant from the X-ray tube 8, the area of the multi slit 11 has to be enlarged, and the enlarged multi slit 11 may bump a radiographic object H and becomes an obstacle of radiography. Therefore, the multi slit 11 is desirably arranged at a position with a distance of about 1 to 10 cm from the X-ray tube 8. Here, in the present invention, the distance between the X-ray tube 8 and other members represents the distance between the focal point of the X-ray tube 8 and other members correctly.

As mentioned above, since X rays irradiated from the X-ray tube 8 are made into multi light sources by the multi slit 11, the multi slit 11 is deemed so to speak as a light source. And, the distance between the first diffraction grating 15 and a light source is required to be adjusted appropriately, in the case of the Talbot interferometer system in which the multi slit 11 is seceded from an optical path of X rays, the distance L between the X-ray tube 8 and the first diffraction grating 15 is adapted to be adjusted in such a way that the first diffraction grating 15 is shifted upward and downward for the holding member 7 by the positioning apparatus 9. Further, in the case of the Talbot Lau interferometer system in which the multi slit 11 is arranged on the optical path of X rays, as mentioned above, since X rays irradiated from the X-ray tube 8 are made into multi light sources by the multi slit 11, the multi slit 11 is deemed so to speak as a light source. Therefore, the distance L between the first diffraction grating 15 and the multi slit 11 as a light source is adjusted in such a way that the first diffraction grating 15 is shifted upward and downward for the holding member 7 by the positioning apparatus 9.

Further, the first diffraction grating 15 and the second diffraction grating 16 are adapted to be able to be arranged on or separated from the optical path of X rays irradiated from the X-ray tube 8, respectively. The first diffraction grating 15 and the second diffraction grating 16 are adapted to be able to be rotated around the shaft of the holding member 7 by being driven by the positioning apparatus 9. Therefore, in the case that the radiation image radiographing apparatus 1 is used as a Talbot interferometer system, the first diffraction grating 15 and the second diffraction grating 16 are rotated around the holding member 7 and are arranged on the optical path. On the other hand, in the case that the radiation image radiographing apparatus 1 is used as a refraction contrast imaging system, the first diffraction grating 15 and the second diffraction grating 16 are rotated around the holding member 7 and are separated from the optical path.

Here, it is also possible to make other driving devices to conduct this rotating operation, or to constitute so that this rotating operation may be conducted manually. Further, in addition, it is also possible to constitute such that, for example, a connecting section between the first diffraction grating 15 and the second diffraction grating 16 and the holding member 7 is structured to be retractable. Therefore, the first diffraction grating 15 and the second diffraction grating 16 is shifted toward the holding member 7 or shifted to be separated from the holding member 7 so that the first diffraction grating 15 and the second diffraction grating 16 is arranged on the optical path of X rays or separated from the optical path.

When the first diffraction grating 15 and the second diffraction grating 16 are separated from the optical path, each of these gratings 15 and 16 may be structured to be merely removed from the holding member 7.

The X-ray detector 17 is set up such that the distance Ltotal between itself and the X-ray tube 8 or the multi-slit 11 as a light source becomes 0.5 m or more. Further, the upper limit of the distance Ltotal is set to about 2 m in consideration of a situation to use the radiation image radiographing apparatus 1 in a room, and the accuracy, intensity, and the like of the radiation image radiographing apparatus 1.

For example, when one of a Talbot interferometer system, a Talbot Lau interferometer system and a refraction contrast imaging system is inputted as a system of the radiation image radiographing apparatus 1 from an input device 22a, and if the tube voltage of a used X-ray tube 8 is set up as mentioned above, the average energy of X rays irradiated from the X-ray tube 8 is determined, and also the tolerance of the distance L between the X-ray tube 8 and the first diffraction grating 15 or the distance L of the multi slit 11 as a light source and the first diffraction grating 15, the distance Z₁ between the first diffraction grating 15 and the second diffraction grating 16, the distance R1 between the X-ray tube 8 and a radiographic object H, and the distance R2 between the radiographic object H and the X-ray detector 17 are determined. Moreover, as mentioned above, in the case that the second diffraction grating 16 and X-ray detector 17 are brought in close contact with each other, in FIG. 11, an enlarging ratio of the photographic object H is decided by the formula of ((R1+R2)/R1) depending on the position of the radiographic object board 12.

Then, in this embodiment, if a system of an apparatus, the tube voltage of the X-ray tube 8, the distance L, the distance Z₁, the enlarging ratio, and the like are inputted through the input device 22a, the control device 20 drives the positioning apparatus 9 based on these inputs and conducts positioning for the X-ray tube 8, the multi slit 11, the first diffraction grating 15, the second diffraction grating 16, and the X-ray detector 17 to the radiographic object board 12. In addition to the positioning in a vertical direction, in accordance with the system set up for the apparatus, the first diffraction grating 15 and the second diffraction grating 16 are rotated around the shaft of the holding member 7 by being driven by the positioning apparatus 9 so that they are arranged on the optical path of X rays (in the case of a Talbot Lau interferometer system and a Talbot interferometer system), or are separated from on the optical path (refraction contrast imaging system). Further, in addition to the positioning in a vertical direction, in accordance with the system set up for the apparatus, multi slit 11 is rotated around the shaft of the holding member 7 by being driven by the positioning apparatus 9 so that it is arranged on the optical path of X rays (in the case of a Talbot Lau interferometer system), or is separated from on the optical path (a Talbot interferometer system).

And then, the supporting stay 3 is shifted upward or downward so as to shift the radiographic object board 12 upward or downward while keeping the positional relationship among the above members in such a way that a patient can take an attitude with which the patient gets hardly tired.

Here, since the positioning must be conducted in such a way that the radiographic object board 12 is not brought in contact with the first diffraction grating 15, there is a limitation in each of the above mentioned distances R1 and R2. Therefore, a range capable of setting up an enlarging ratio ((R1+R2)/R1) is restricted. Therefore, it is also possible to constitute such that a range capable of setting up an enlarging ratio may be displayed on a display device 22b at the stage when the tube voltage of the X-ray tube 8, the distance L, the distance Z₁, and an enlarging ratio are inputted.

In this case, if a system for an apparatus and a tube voltage are inputted, the positioning for the X-ray tube 8, the first diffraction grating 15, the second diffraction grating 16, and X-ray detector 17 is conducted automatically. Further, if an enlarging ratio is inputted, the positioning between them and the radiographic object board 12 is conducted in accordance with the inputted enlarging ratio.

Furthermore, in this embodiment, in the case of a Talbot Lau interferometer system, the distance between the X-ray tube 8 and the multi slit 11 arranged beneath the X-ray tube 8 is set to the distance set up beforehand. However, this distance may be set up by being inputted simultaneously at the time of inputting a system for of an apparatus, a tube voltage of the X-ray tube 8 and the like, or a LUT may be prepared so as to set up a suitable distance to a system of an apparatus and a tube voltage of the X-ray tube 8.

Moreover, when one of a Talbot interferometer system, a Talbot Lau interferometer system and a refraction contrast imaging system is inputted and a tube voltage of a used X-ray tube 8 is set up, as mentioned above, the control device 20 is adapted to conduct switching a focal size of the X-ray tube 8 by changing the angle of a target of the X-ray tube in accordance with a system of an apparatus.

In addition to the positioning for the X-ray tube 8 and the like in the above manner, the control device 20 drives the driving device 6 to rotate the supporting shaft 5 in the CW direction or the CCW direction shown in FIG. 12 so that the radiographing apparatus main body 4 is rotated around a radiographic object H, whereby a radiation irradiation angle is adjusted.

Moreover, at the time that the radiation image radiographing apparatus 1 works, the control device 20 irradiates a radiographic object H with X rays emitted from the X-ray tube 8 in accordance with an electric power supplied from the power source section 10 (in the case of a Talbot Lau interferometer system, X rays are made to multi light sources by a multi slit, and then are irradiated to a radiographic object). At this time, if an amount of X-rays detected by the X-ray amount detecting device 21 reaches a predetermined X-ray amount set up beforehand, the control device 20 stops the supply of the electric power from the power source section 10 to the X-ray tube 8, whereby the X-ray tube 8 stops emitting X rays. Here, the emitting conditions of X rays are set up suitably in the light of factors other than an amount of X-rays detected by the radiation amount detecting device 21, namely, such as the kind of the X-ray detector 17.

In this embodiment, the control device 20 drives the drive unit 6 to rotate the supporting shaft 5 so as to rotate the radiographing apparatus main body 4 in such a way that the X-ray tube 8 and the X-ray detector 17 (also, the first diffraction grating 15 and the second diffraction grating 16 in the case of a Talbot interferometer system, and further a multi slit in the case of a Talbot Lau interferometer system) are rotated around a radiographic object H, whereby the radiographic object H is irradiated with X rays from plural directions and radiation images of the radiographic object H can be taken successively. Here, an amount of rotation of the radiographing apparatus main body 4 and a radiographic timing (a timing to take a radiation image for each of some degrees of rotation angles) are set up by being inputted from the input device 22a.

Moreover, in this embodiment, the control device 20 is constituted to detect an abnormal shade candidate from the taken X-ray image. In the case that an abnormal shade candidate is detected, in order to take the abnormal shade candidate more clearly, the control device 20 is adapted to switch an apparatus from a refraction contrast imaging system to a Talbot interferometer system.

The detection of an abnormal shade candidate from an X-ray image can be conducted by, for example, the technique of a medical imaging diagnostic supporting system disclosed in an official report of the Japanese Patent Unexamined Publication No. 2005-102936 filed previously by the applicant of the present patent application. In this system, a medical image such as an X-ray image is analyzed with an image analyzing technique so as to calculate an amount of features and an abnormal shade candidate is detected from an image based on the amount of features.

Here, it is also possible to constitute such that an apparatus to detect an abnormal shade candidate from an X-ray image taken by this radiation image radiographing apparatus 1 is structured as a diagnostic supporting apparatus (not illustrated in any drawing) with an apparatus separate from the radiation image radiographing apparatus 1 and is provided in a radiation image radiographing system 100 by being connected with the radiation image radiographing apparatus 1 through a network N.

In this case, for example, if the diagnostic support apparatus detects an abnormal shade candidate and transmits the information of it, the control device 20 of the radiation image radiographing apparatus 1 can be constituted so as to switch the radiation image radiographing apparatus 1 from a refraction contrast imaging system to a Talbot interferometer system based on the information.

Next, a Talbot Lau interferometer constituted in the radiation image radiographing apparatus 1 of this embodiment will be explained, and also the operations of the radiation image radiographing apparatus 1 will be explained together with the explanation for the structures of the multi slit 11, the first diffraction grating 15 and the second diffraction grating 16, and the positional relationship between them and the X-ray detector 17.

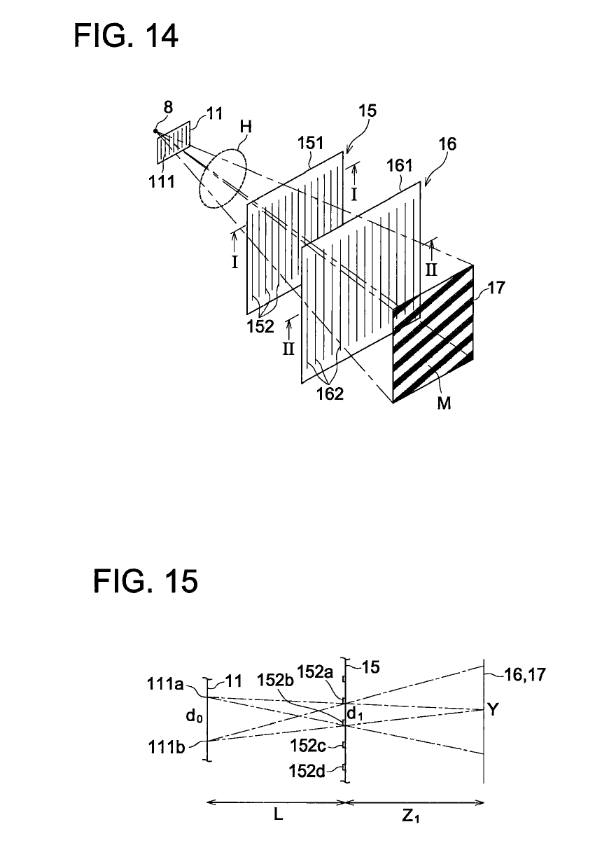

In this embodiment, as shown in FIGS. 6 and 14, X rays irradiated from the X-ray tube 8 in the case of FIG. 14 are adapted to pass through the multi-slit 11, pass through a radiographic object H, pass through the first diffraction grating 15 and the second diffraction grating 16, and enter into the X-ray detector 17. As are shown in FIG. 6, a Talbot interferometer is constituted by the X-ray tube 8, the first diffraction grating 15, and the second diffraction grating 16, and as shown in FIG. 14, a Talbot Lau interferometer is constituted by the X-ray tube 8, the multi slit 11, the first diffraction grating 15, and the second diffraction grating 16.

Next, the structure of the multi slit 11 will be explained. In the case that the radiation image radiographing apparatus 1 is used as a Talbot Lau interferometer system, as shown in FIG. 15, the multi slit 11 is separated from the first diffraction grating 15 by a distance L. Further, X rays having passed through one slit 111a of the multi slit 11 form a self-image of a diffractive member 152a of the first diffraction grating 15 and a self-image of a diffractive member 152b on the second diffraction grating 16 (the X-ray detector 17 located almost close to it) arranged at a position separated by only a distance Z₁ from the first diffraction grating 15.

Further, the self-image of each of the diffractive members 152a and 152b of the first diffraction grating 15 is also formed on the second diffraction grating 16 respectively by X rays having passed through a slit 111b adjacent to the slit 111a of the multi slit 11. That is, self images of each diffractive member 152 of the first diffraction grating 15 are formed in the shape of stripes on the second diffraction grating 16 by X rays having passed through each slit 111 of the multi slit 11.

at this time, if the slit distance d₀ of the slit 111 of the multi slit 11 is not suitable, self-images in the shape of stripes formed on the second diffraction grating 16 by each of X rays having passed through the slits 111a and 111b of the multi slit 11 are negated with each others.

However, as shown in FIG. 15, if the slit distance d₀ is adjusted such that the self-image of the diffractive member 152a formed by X rays having passed through the slit 111a and the self-image of the diffractive member 152b formed by the X rays having passed through the slit 111b are overlapped with each other at the position of Y on the second diffraction grating 16, the stripes of the respective self-images are overlapped with each other, so to speak, to make an in-focus condition.

In this case, among the slit distance d₀ of the slits 111 of a multi slit 11, the distance (lattice pitch) d₁ between the diffractive members 152 of the first diffraction grating 15, the distance L between the multi slit 11 and the first diffraction grating 15, and the distances Z₁ from the first diffraction grating 15 to the second diffraction grating 16, the relationship represented by Formula (d₀:d₁=(L+Z₁):Z₁) is established. If this is solved, the slit distance d₀ is represented by Formula (2)

$$\begin{matrix}Formula ( 2 ) & \\ {d}_{0} = \frac{L + {Z}_{1}}{{Z}_{1}} {d}_{1} & ( 2 )\end{matrix}$$

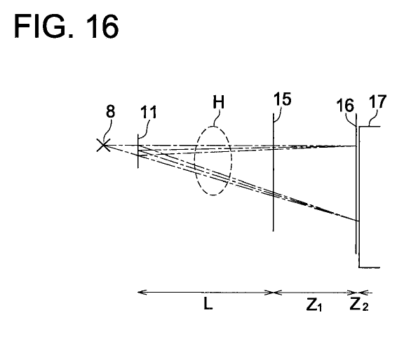

Further, in FIG. 16, the consideration has been applied to the case that X rays having passed through the slits 111a and 111b of the multi slit 11 pass through portions of the diffractive members 152a and 152b adjacent to the first diffraction grating 15. However, for example, in the case that X rays pass through a portion of the diffractive member 152a and portions such as the diffractive member 152c and the diffractive members 152d which are at positions distant by an integral multiple of the lattice pitch d₁ from the diffractive member 152a, that is, in the case that the relationship of Formula (3) in which “d₁” in Formula (2) is made to “pd₁” by being multiplied with an integer “p”, stripes of the self-image of the first diffraction grating 15 are overlapped exactly to each other, and an in-focus is made.

$$\begin{matrix}Formula ( 3 ) & \\ {d}_{0} = \frac{L + {Z}_{1}}{{Z}_{1}} {pd}_{1} & ( 3 )\end{matrix}$$

Further, as mentioned above, (L+Z₁+Z₂) is represented with Ltotal (L+Z₁+Z₂=Ltotal), and since the distance Z₂ between the second diffraction grating 16 and the X-ray detector 17 is almost 0, Formula (3) may be represented with the following Formula (4).

$$\begin{matrix}Formula ( 4 ) & \\ {d}_{0} = \frac{Ltotal}{{Z}_{1}} {pd}_{1} & ( 4 )\end{matrix}$$

That is, if the multi slit 11 is appropriately formed such that the slit distance d₀ of the slits 111a satisfied Formula (3) and Formula (4), X rays having passed through each of the slits 111 of the multi slit 11 form the self-image of the first diffraction grating 15 effectively respectively on the second diffraction grating 16, the respective self-images are overlapped with each other to be able to become an in-focus image.

Next, in the case that the radiation image radiographing apparatus 1 is used as a Talbot Lau interferometer system shown in FIG. 14, the condition to constitute a Talbot Lau interferometer by the X-ray tube 8, the multi slit 11, the first diffraction grating 15, and the second diffraction grating 16 will be explained.

In this case, theoretically, as with the case of the above-mentioned Talbot interferometer system, the distance Z₁ between the first diffraction grating 15 and the second diffraction grating 16 is set up to satisfy Formula (1). And, as shown in FIG. 16, the Talbot effect mentioned above is caused by X rays having passed through each of the slits 111 of the multi slit 11 respectively. And, the self-image of the first diffraction grating 15 is formed at the position separated by only a distance Z₁ from the first diffraction grating 15 by X rays having passed through each of the slits 111. At this time, if the slit distance d₀ of the multi slit 11 is structured to satisfy Formula (3) and Formula (4), these self-images are overlapped with each other at the position separated by only a distance Z₁ from the first diffraction grating 15, whereby these self-images become in-focus images.

Therefore, if the second diffraction grating 16 on the condition that the extending direction of the diffractive member 162 is rotated by only a minute angle θ relatively to the extending direction of the diffractive member 152 of the first diffraction grating 15, is placed on the position with the distance Z₁ given by Formula (1), moire stripes appear, and a moire stripe image in which moire stripes M as shown in FIG. 14 are mirrored, is detected by the X-ray detector 17.

On the other hand, if a radiographic object H exists between the multi slit 11 and the first diffraction grating 15, when X rays are irradiated from the X-ray tube 8 and pass through the multi slit 11 and radiographic object H, since the phase of each X ray is deviated due to the radiographic object H while the X rays are passing through the radiographic object H, the wave front of each of X rays entering into the first diffraction grating 15 is distorted, respectively. Therefore, the self-image of the first diffraction grating 15 deforms depending on it.

And, when each of X rays diffracted by the first diffraction grating 15 passes through the second diffraction grating 16, according to the distortion of the wave front of each of X rays, moire-stripes M are also distorted in accordance with the shape of the radiographic object H. At this time, since X rays pass through the inner portion of the radiographic object H, the X rays is distorted also in accordance with the shape of the inner portion of the radiographic object H, and such distortions are mirrored in the moire stripes M. Thus, when moire stripes M having distorted in accordance with the configurations of the radiographic object H and its inner portion is detected even by an ordinary X-ray detector 17, it becomes possible to obtain an X-ray image of the photographic object H which mirrors the configurations of the radiographic object H and its inner portion.

Next, the refraction contrast imaging system executed in the radiation image radiographing apparatus 1 of this embodiment is explained, and the action of the radiation image radiographing apparatus 1 is explained together with the explanations of the structures of the multi slit 11, the first diffraction grating 15 and the second diffraction grating 16, the positional relationship between them and the X-ray detector 17.

In this embodiment, in the case of the refraction contrast imaging system, since all of the multi slits 11, the first diffraction grating 15, and the second diffraction grating 16 are separated from the optical path of the X rays irradiated from the X-ray tube 8, X rays irradiated from the X-ray tube 8 pass through a radiographic object H, and enter into the X-ray detector 17.

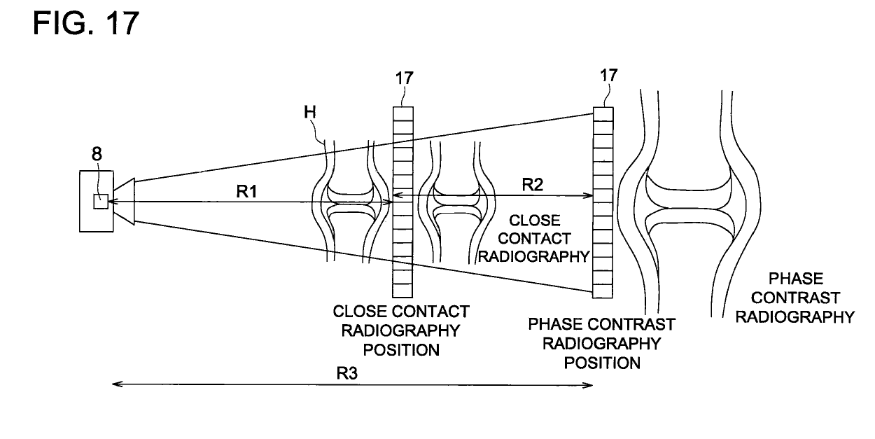

FIG. 17 is an illustration for explaining an outline of the refraction contrast imaging system. As shown in FIG. 17, in an ordinary radiography method, a radiographic object H is arranged at a position where the radiographic object H comes in contact with the X-ray detector 17 (close contact radiography position in FIG. 17). In this case, an X-ray image (latent image) recorded on the X-ray detector 17 becomes an almost equal size of a life size (it means the same size as the radiographic object H).

As compared with this, in the refraction contrast imaging system, a distance is provided between the radiographic object H and the X-ray detector 17, and a latent image of an X-ray image (hereafter, referred to as an enlarged image) enlarged larger than the life size by X rays irradiated in the shape of a cone beam from the X-ray tube 8 is detected by the X-ray detector 17.

Here, when the distance from the focal point of the X-ray source 8 to a radiographic object H is R1, the distance from the radiographic object H to the X-ray detector 17 is R2, and the distance from the focal point of X-ray tube 8 to the X-ray detector 17 is R3 (R3=R1+R2), an enlarged ratio M of an enlarged image to a life size can be obtained by the following Formula (5).

M=R3/R1 (5)

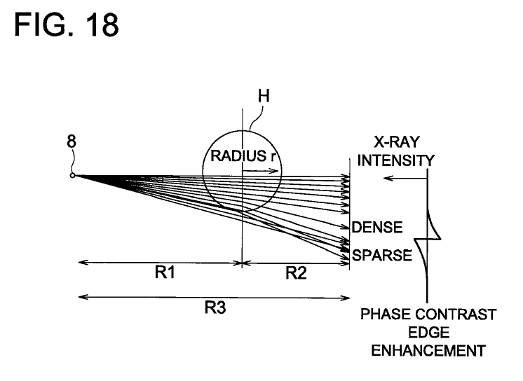

In the refraction contrast imaging system, as shown in FIG. 18, X rays having refracted by passing through a periphery of an photographic object H and X rays having not passed through the photographic object H are overlapped on the X-ray detector 17, and the intensity of X rays on the overlapped portion becomes strong. On the other hand, a phenomenon takes place such that the intensity of X rays becomes weak on a portion at the inside of the periphery of the radiographic object H corresponding to the amount of the refracted X rays. Therefore, an edge enhancing action (it is also called “edge effect”) works to expand a difference in intensity of X rays at both sides of a border line of a periphery of the photographic object, whereby the peripheral portions are depicted with sharpness so that an X-ray image with high visibility can be obtained.

Even in the case that the setup of the distance R3 is restricted due to the size of a radiography room, a radiography can be conducted on an optimal condition in such a way that the distance R3 is fixed and the ratio of the distance R1 to the distance R2 is changed within the fixed distance R3. For example, in the case that the condition (R3=2.0 (m)) is determined, other conditions (R1=1.0 (m)) and (R2=1.0 (m)) are determined for the distance R3. Further, in the case of taking the size of an ordinary radiography room into consideration, distances are made within ranges of (0.1≦R1≦1.5), (0.3≦R2≦1.5), and (0.8≦R3≦2.0), an enlarging ratio M is made to a range of (1.5≦M≦10), and a focal size D is made within a range of (0.03 (mm)≦D≦0.2 (mm)). Accordingly, the distances R1, R2 and R3, the enlarging ratio M and the focal size D may be determined to optimal values experientially and experimentally within the above ranges with the consideration for the relationship with the visibility of an enlarged image. With the selection of a focal size D within the above range, the intensity of X rays becomes strong, and a radiography can be conducted with a short time so that a motion blur du to motion of a radiographic object H can be made small. Here, more preferable examples, the distances may be within ranges of (0.5≦R1≦1.2), (0.5≦R2≦1.2), and (1.0≦R3≦2.0), the enlarging ratio M may be within a range of (3≦M≦8), and the focal size D may be within a range of (0.05 (mm)≦D≦0.12 (mm)).

If the enlarging ratio M is larger, a more microscopic image can be obtained. Therefore, the accuracy of a quantitative analysis becomes higher. On the other hand, for the larger enlarging radiography, since a X-ray tube with a smaller focal size is needed, an output becomes smaller and an exposure time becomes longer. Therefore, blur may be easily caused by motion of a radiographic object, and the sharpness of an image is spoiled. Accordingly, since an image analysis cannot conducted with high accuracy, the enlarging ratio M within the above range is preferable actually.

Thus, various setup conditions of the radiation image radiographing apparatus 1 become different depending on respective cases of the Talbot interferometer system, the Talbot Lau interferometer system, and the refraction contrast imaging system. Therefore, as mentioned above, for example, when an abnormal shade candidate is detected from an X-ray image, or a diagnostic supporting apparatus of the radiation image radiographing system 100 detects an abnormal shade candidate from an X-ray image and transmits the information, in order to take an image of the abnormal shade candidate more clearly, the control device 20 switches from the refraction contrast imaging system to the Talbot interferometer system.

In that case, the control device 20 rotates the first diffraction grating 15 and the second diffraction grating 16 around the shaft of the holding member 7 and arranges them on an optical path of X rays, and further the control device 20 changes the angle of a target of an X-ray tube and switches the focal size of the X-ray tube 8. Further, in the refraction contrast imaging system, the distance L is adjusted as a distance between the multi slit 11 and the first diffraction grating 15. However, in the Talbot interferometer system, the multi slit 11 is separated away and the distance L is adjusted as a distance between the X-ray tube 8 and the first diffraction grating 15. Therefore, since targets to be adjusted change somewhat, positioning is conducted suitably for the X-ray tube 8, the first diffraction grating 15, the second diffraction grating 16, and X-ray detector 17 if needed.

In the case of switching from the Talbot interferometer system to the refraction contrast imaging system, the control device 20 conducts operations contrary to the above.

As mentioned above, according to the radiation image radiographing apparatus 1 relating to this embodiment, the first diffraction grating 15 and the second diffraction grating 16 are controlled to be arranged on an optical path of X rays or separated from the optical path, whereby the Talbot interferometer system and the refraction contrast imaging system can be switched over. Here, in the Talbot interferometer system or the Talbot Lau interferometer system, a diffraction grating and its positional adjustment are needed, and a microfocus X-ray tube and a multi slit are needed to acquire a coherency. However, in the refraction contrast method, these member and the positional adjustment become unnecessary. Here, although there may be differences in some extent depending on radiographic parts as mentioned above, the Talbot interferometer system and the Talbot Lau interferometer system are better generally in terms of sharpness. Features become different depending on the respective systems. However, as described above, if the Talbot interferometer system and the refraction contrast imaging system can be switched over from each other, a more effective radiography method can be chosen for any radiographic part (for example, a joint, a breast, a child, and the like), or even for the same part, further a specific part specifically required with high resolution (for example, even in a joint image, depending on a bone, soft tissue, or a cartilage), whereby a radiation image in which the contrast of a peripheral portion is emphasized can be obtained.

Therefore, for example, with a technique to radiograph a photographic object over a broad are by the refraction contrast imaging system, to switch from the refraction contrast imaging system to the Talbot interferometer system, and to radiograph a diseased part clearly more by the Talbot interferometer system, it becomes possible to obtain a good X-ray image with an emphasized contrast on its peripheral portion by the Talbot interferometer type and the Talbot Lau interferometer type from organization parts from which it is difficult to obtain an X-ray image by an ordinary X-ray machine, such as an articular diseased part represented by rheumatism, a breast which is organized with soft tissue in its almost all portion and is required to detect calcified microscopic portions, and a child in which almost all of bones are cartilages.

Further, if an image processing is conducted appropriately by the image processing apparatus 30 of the radiation image radiographing system 100, a clearer X image can obtained, and it also becomes possible to obtain a three-dimensional image of a photographic object H and an image an emphasized part in which symptom have appeared.

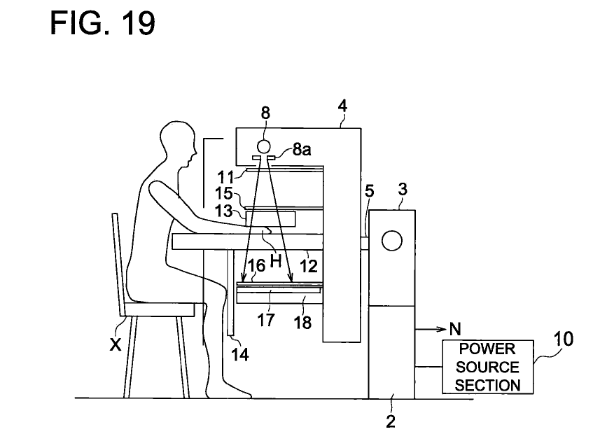

Here, instead of the structure in which a radiographic object H (radiographic object board 12) is arranged between the multi slit 11 and the first diffraction grating 15 (or between the X-ray tube 8 and the first diffraction grating 15 in the case of using an apparatus as a Talbot interferometer system) as with the radiation image radiographing apparatus 1 shown in FIG. 11 and relating to this embodiment, for example, it is also possible to structure to arrange a radiographic object H between the first diffraction grating 15 and the second diffraction grating 16 as with the radiation image radiographing apparatus shown in FIG. 19.

In that case, the first diffraction grating 15 becomes the condition that the first diffraction grating 15 is arranged closer to the multi slit 11 and the X-ray tube 8 as compared with the radiation image radiographing apparatus 1 in this embodiment. X rays entering into the first diffraction grating are needed to have a coherency. For that purpose, when the multi slit 11 is used in the case that the apparatus is used as the Talbot Lau interferometer system shown in FIG. 14, the width (namely, so-called slit width) of an opening section of each slit 111 of the multi slit 11 is formed in about 0.1 to 10 μm, preferably about 1 to 5 μm. With this, X rays entering into the first diffraction grating 15 become to have a coherency, and high energy X rays irradiated from the X-ray tube 8 are made properly to Lau energy, and made into multi light sources.

1.-13. (canceled)

14. A radiation image radiographing apparatus, comprising:
an X-ray tube having a focal size of 1 μm or more and to irradiate X-rays with an average energy of 15 to 60 keV;
a radiographic object board to place a radiographic object thereon;
a first diffraction grating to diffract X-rays and to cause a Talbot effect to form a self-image by the X-rays;
a second diffraction grating to diffract the X rays diffracted by the first diffraction grating; and
an X-ray detector to detect the X rays diffracted by the second diffraction grating;
wherein the second diffraction grating is arranged so as to come in contact with the X-ray detector, a distance between the X-ray tube and the first diffraction grating is set to 0.5 m or more, and a distance between the first diffraction grating and the second diffraction grating is set to 0.05 m or more.

15. The radiation image radiographing apparatus described in claim 14, further comprising:
a position adjusting device to adjust a position of each of the X-ray tube, the first diffraction grating and the second diffraction grating.

16. The radiation image radiographing apparatus described in claim 14, wherein the radiographic object base is arranged between the X-ray tube and the first diffraction grating.

17. The radiation image radiographing apparatus described in claim 14, wherein the radiographic object base is arranged between the first diffraction grating and the second diffraction grating.

18. The radiation image radiographing apparatus described in claim 14, further comprising:
a control device to compare a moire stripe image having been captured before a start of an initial operation of the radiation image radiographing apparatus with a moire stripe image having been captured after the start of the initial operation so as to judge whether or not a distortion takes place on the first diffraction grating and the second diffraction grating.

19. The radiation image radiographing apparatus described in claim 18, wherein the control device conducts warning in accordance with the judgment result.

20. The radiation image radiographing apparatus described in claim 14, further comprising:
a temperature sensor to measure a temperature of each of the first diffraction grating and the second diffraction grating; and
a control device to judge whether or not the temperature of each of the first diffraction grating and the second diffraction grating measured by the temperature sensor is higher than a preset temperature.

21. The radiation image radiographing apparatus described in claim 20, wherein the control device conducts warning in accordance with the judgment result.

22. The radiation image radiographing apparatus described in claim 14, wherein the X-ray tube, the first diffraction grating, the second diffraction grating, and the X-ray detector are structured to rotate around a radiographic object so as to enable the radiographic object to be radiographed successively from plural different directions.

23. The radiation image radiographing apparatus described in claim 14, wherein the first diffraction grating and the second diffraction grating are structured to be arranged on or separated from an optical path of X-rays irradiated from the X-ray tube, and
wherein the radiation image radiographing apparatus further comprises a control device to control the first diffraction grating and the second diffraction grating to be arranged on or separated from an optical path of X-rays so as to switch between a Talbot interferometer system and a refraction contrast imaging system.

24. The radiation image radiographing apparatus described in claim 23, further comprising:
a multi slit having plural slits and structured to be arranged on or separated from an optical path of X-rays irradiated from the X-ray tube,
wherein the control device controls the multi slit to be arranged on or separated from an optical path of X-rays so as to switch between a Talbot interferometer system and a Talbot Lau interferometer system.

25. The radiation image radiographing apparatus described in claim 23, wherein the control device is adapted to detect an abnormal shade candidate from the radiation image, and
wherein when the control device detects an abnormal shade candidate, the control device switches over from the refraction contrast imaging system to the Talbot interferometer system.

26. A radiation image radiographing system, comprising:
the radiation image radiographing apparatus described in claim 18;
an image processing apparatus to process a radiation image radiographed by the radiation image radiographing apparatus; and
an image output apparatus to output the radiation image processed by the image processing apparatus,
wherein based on image data of a moire stripe image radiographed beforehand by the radiation image radiographing apparatus on a condition that a radiographic object is not place on the radiographic object board, the image processing apparatus corrects image data of a radiation image radiographed by the radiation image radiographing apparatus on a condition that an radiographic object is placed on the radiographic object board.

27. A radiation image radiographing system, comprising:
the radiation image radiographing apparatus described in claim 22;
an image processing apparatus to process a radiation image radiographed by the radiation image radiographing apparatus; and
an image output apparatus to output the radiation image processed by the image processing apparatus,
wherein the image processing apparatus forms a three-dimensional image of a radiographic object from plural radiation images of the radiographic object radiographed successively from plural different directions by the radiation image radiographing apparatus and the image output apparatus outputs the three-dimensional image.

28. A radiation image radiographing system, comprising:
the radiation image radiographing apparatus described in claim 23; and
a diagnosis supporting apparatus to detect an abnormal shade candidate from a radiation image radiographed by the radiation image radiographing apparatus,
wherein when the diagnosis supporting apparatus detects an abnormal shade candidate, the control device of the radiation image radiographing apparatus switches over from the refraction contrast imaging system to the Talbot interferometer system.
